(19) United States
(12) Patent Application Publication
(10) Pub. No.: US 2014/0346992 A1
(43) Pub. Date: Nov. 27, 2014

(54) METHOD AND APPARATUS FOR GENERATING ELECTRICAL AND MECHANICAL ENERGY

(71) Applicant: Lawrence Ashley Farwell, Seattle, WA (US)

(72) Inventor: Lawrence Ashley Farwell, Seattle, WA (US)

(21) Appl. No.: 13/902,962

(22) Filed: May 27, 2013

(51) Int. Cl. H02P 6/16; H02K 11/00; H02K 1/06

(52) U.S. Cl. CPC H02P 6/16; H02K 1/06; H02K 11/001; Y10S 74/09; H02K 53/00
USPC 318/400.37; 310/152; 74/DIG. 9

(57) ABSTRACT

A method and apparatus for generating electrical energy comprises driven permanent magnets mounted tangentially on a freely rotating disk attached to a relatively stationary platform, and driver permanent magnets mounted on the platform radially to the disk. As the disk rotates, as a driven magnet approaches a driver magnet, their respective opposite poles attract, accelerating the disk. After the driven magnet passes the driver magnet, their like poles repel, also accelerating the disk. When the two permanent magnets are in close proximity, such that repulsion between like poles would decelerate the disk, an electromagnet is engaged between the two permanent to counteract this counterproductive force. One or more coils generate electricity through electromagnetic induction when the driven magnet passes them. A portion of this electricity powers the electromagnet, and the balance is the net energy generated.

### REFERENCES CITED

U.S. PATENT DOCUMENTS

| | | |
|---|---|---|
| 3,890,548 | Gray | June 1975 |
| 3,913,004 | Alexander | October 1975 |
| 4,009,406 | Inariba | February 1977 |
| 4,151,431 | Johnson | April 1979 |
| 4,179,633 | Kelly | December 1979 |
| 4,595,975 | Gray | June 1986 |
| 4,772,816 | Spence | September 1988 |
| 4,823,038 | Mizutani et al. | April 1989 |
| 5,363,858 | Farwell | November 1994 |
| 5,406,956 | Farwell | April 1995 |
| 5,436,518 | Kawai | July 1995 |
| 5,449,989 | Correa, Paulo, and Alexandra | September 1995 |
| 5,455,474 | Flynn | October 1995 |
| 5,467,777 | Farwell | November 1995 |
| 5,892,311 | Hayasaka | April 1996 |
| 5,590,031 | Mead and Nachamkin | December 1996 |
| 5,625,241 | Ewing | April 1997 |
| 5,694,419 | Rakestraw et al. | December 1997 |
| 5,821,710 | Masuzawa et al. | October 1998 |
| 5,973,436 | Satoh et al. | May 2000 |
| 6,208,061 | An | March 2001 |
| 6,246,561 | Flynn | June 2001 |
| 6,362,718 | Patrick et al. | March 2002 |
| 6,373,161 | Khalaf | April 2002 |
| 6,392,370 | Bedini | May 2002 |
| 6,462,451 | Kimura et al. | October 2002 |
| 6,541,877 | Kim et al. | April 2003 |
| 6,545,444 | Bedini | April 2003 |
| 6,717,313 | Bae | April 2004 |
| 6,867,514 | Fecera | March 2005 |
| 6,946,767 | Reardon | September 2005 |
| 7,151,332 | Kundel | December 2006 |
| 7,689,272 | Farwell | March 2010 |

U.K. PATENT DOCUMENTS

| | | |
|---|---|---|
| GB 763,062 | Colman and Seddon-Gillespie | December 1956 |
| GB 2,282,708 | Aspden and Adams | April 1995 |

### OTHER PUBLICATIONS

Farwell, L. A. (1999) How Consciousness Commands Matter: The New Scientific Revolution and the Evidence that Anything Is Possible. Fairfield, Iowa: SunStar Press
Farwell, L. A., Martinerie, J. M., Bashore, T. R., Rapp, P. E., & Goddard, P. H. (1993) Optimal digital filters for long-latency components of the event-related brain potential. Psychophysiology 30(3), 306-315
Rapp, P. E., Albano, A. M., Schmah, T. I., & Farwell, L. A. (1993). Filtered noise can mimic low dimensional chaotic attractors. Physical Review E 47(4), 2289-2297
Horowitz, P. & Hill, W. (2001) The Art of Electronics. Cambridge: Cambridge University Press. ISBN 0 521 37095 7.

### BACKGROUND OF THE INVENTION

The four fundamental interactions in physics are gravity, electromagnetism, weak interaction (also known as weak nuclear force), and strong interaction (also known as strong nuclear force). Electromagnetism and gravity are the primary forces whose effects are observable on large objects. Gravity always results in attraction between objects. Electromagnetism results in either attraction or repulsion.

These four forces are inherent, inexhaustible forces. They are inherent in that they exist by virtue of the qualities and configurations of the types of matter involved. Nothing must be done to generate them. They are inexhaustible in that they do not diminish when they are applied. They are not consumed when they are used to do work. For example, the gravitational qualities of a ball and the earth exist due to their mass. As long as the mass does not change, the gravitational qualities do not change. When the ball is dropped from a height and falls to the earth (moving the earth slightly in its direction as well according to Newton's Second Law, F=ma and Newton's Third Law of equal and opposite forces), its gravitational properties and that of the earth do not change. The gravitational attraction between the moon for the earth results in a constant acceleration of the moon in a direction perpendicular to its motion around the earth. The force of gravity produces this acceleration continuously, and never gets consumed or diminished in the process.

Moving electric charges or fields generate magnetic fields, and vice versa. The magnetism displayed by a magnetized metal object can be thought of in terms of large numbers of charged particles, specifically electrons, moving in approximately circular patterns in the same plane within the magnet, thus creating a net magnetic force. The magnetic field is perpendicular to the plane of motion of the charged particles. Magnets have two poles, a north pole and a south pole. When magnets are in the proximity of other magnets, like poles repel each other and opposite poles attract.

Due to the universal attraction of gravity, all objects that have mass have potential energy by virtue of two factors: gravity and their position in relation to other objects that have mass. Two magnets in proximity to each other have potential energy by virtue of three factors: the attraction or repulsion of their magnetic fields, their relative position, and their relative orientation (that is, with like poles facing each other, with opposite poles facing each other, etc.).

When two objects move closer together by virtue of the attraction of gravity, the gravitational properties of the objects do not change. Both objects still attract other objects with a force directly related to their mass and inversely related to the distance between them. As long as the mass does not change, the gravitational field around an object does not change. Another way of saying this is that when the potential energy arising from the relative position of the objects and their gravitational attraction to each other is converted to mechanical energy, gravity is not consumed. What is lost is the potential due to their relative position.

The same is true of magnets. When two magnets move closer to each other by virtue of the magnetic attraction of their opposite poles, some of the potential energy that was present by virtue of the magnetic attraction and their relative position and orientation is converted to mechanical energy. The magnetic fields surrounding the magnets to not change. Their magnetism does not get consumed.

Electromagnets generated by moving electric fields, generally by a coil of conductive material through which a current is passed, require continuous input of energy to maintain the motion of the electrical field and the magnetic field it generates. Permanent magnets, however, require no input of energy. Their magnetic fields are a property that is not lost, changed, or consumed when potential energy is converted to mechanical energy.

When two magnets move closer together due to magnetic attraction, a certain amount of mechanical energy is generated. This mechanical energy can be used to do work, or can be converted to electrical energy through well known means. Similarly, when two massive objects move closer to each other due to gravitational attraction, a certain amount of mechanical energy is produced, which can be used to do work or converted to electrical energy.

If, after having moved closer due to gravitational attraction, the two objects are restored to their original position, this energy-generating process can be repeated. If left free to move, they will move closer again due to gravitational attraction, and additional energy can be harvested. The gravitational attraction is not a quality that gets consumed when it is applied to produce mechanical energy.

For example, a heavy ball can be dropped from a height in the earth's gravitational field while attached to a cable wound around a drum. As the ball falls, the cable forces the drum to rotate, and this motion can be used to generate electricity. The drum can then be forcibly rotated in the opposite direction, the ball can be raised to its initial position, and the process can be repeated. Work must be done, energy must be input into the system, to return the ball to its initial position. This is an example of a symmetrical system. The same essential reasoning applies to two magnets with opposite facing poles.

In symmetrical systems, the amount of energy required to restore the objects to their initial position and orientation is equal to the energy gained when they moved closer together due to the force of attraction (or farther apart due to repulsion). No mechanism for controlling the objects, harvesting the energy, and returning them to their initial position is 100% efficient, however. Some energy is lost to friction and other inefficiencies in the system. Thus, all symmetrical systems, when operated continually, result in a net loss of energy.

Symmetrical systems are useful for converting one type of energy into another. Electrical generators and electric motors are symmetrical systems that operate on the principal that a changing or moving magnetic field creates an electric field, and vice versa. When a magnet and the corresponding magnetic field it generates move in relation to a coil of a conductor such as copper, an electric current is generated in the conductor. Conversely, an electrical current in a conductive coil generates a magnetic field that can be used to move objects by the application of the force of magnetic attraction and/or repulsion.

An electric generator converts mechanical energy to electrical energy. It applies mechanical energy to forcibly move magnets closer to each other and farther away from each other, usually in a repeating circular pattern, and generates electrical energy by use of coils in which the moving magnetic field produces an electrical current. An electric motor does the reverse. It applies electrical energy to create magnetic fields, the magnetic fields cause objects to move in relation to each other, again usually in a repetitive circular motion, and the resulting output is mechanical energy that can be used to do work.

Symmetrical systems convert one type of energy to another. They produce energy as their moving parts move by virtue of attraction or repulsion, and they consume energy as these same moving parts are restored to their initial positions. Symmetrical systems always result in a net loss of energy for two reasons: (1) the input of energy required to restore their components to their initial positions is equal to the energy gained when the components moved due to attraction and repulsion, and (2) some energy is lost due to friction and other inefficiencies in the system. In principal, symmetrical systems have an energy generating stroke when their components move due to the forces at work, and a restorative stroke when their components are restored to their initial positions. The energy gained in the energy generating stroke is always less than or equal to the energy expended in the restorative stroke. (Often such systems work with rotational motion and multiple components such that these two strokes may overlap.)

The defining characteristic of asymmetrical systems is that to restore the components to their initial condition they use a fundamentally different modality than what was applied in the energy generating stroke. By using a different modality in an asymmetrical fashion, asymmetrical systems can in some cases expend less energy in the restorative stroke than in the energy generating stroke.

A hydroelectric power plant makes use of the force of gravity and the potential energy of water behind a dam to generate electricity. There is a loss of potential energy when the water flows downward through the turbines due to the force of gravity. If the plant then pumped the water back up behind the dam to restore the potential energy based on the positioning of the water and the force of gravity, there would be a net loss of energy because the process would be less than 100% efficient. The water gets restored to its initial position in a different way, however. Water evaporates, ultimately due to energy input from the sun, the evaporated water condenses and falls as rain, and this replenishes the water behind the dam. There is a net gain of energy because the system extracts energy when the water flows downward by converting potential energy due to position and gravity into mechanical energy, then takes advantage of a naturally occurring phenomenon wherein energy is input into the system to restore water to its initial position and thereby restore the corresponding potential energy. A dam uses selective isolation to connect its apparatus to the energy generating stroke, and isolate it from the restorative stroke.

The present invention uses the following features, among others, to create a novel method and asymmetrical apparatus for generating energy.

Inherent inexhaustible force. Inherent, inexhaustible forces exist as an inherent, permanent property of objects that is not consumed when the force is used to generate motion by attracting or repelling other objects. The force will never be exhausted, unless the fundamental nature of the object is changed. The inherent inexhaustible force applied in the present invention is electromagnetism.

Positioning. The same object in different positions with respect to other objects has different effects and exerts different forces. For example, a fixed powerful magnet will exert a powerful repulsive force on a movable powerful magnet in close proximity with an opposite facing pole, resulting in the movable magnet accelerating away from the fixed magnet. A much less powerful fixed magnet placed between the two, with an opposite pole facing the movable magnet, can eliminate this repulsive force and halt the distancing motion even though it is much less powerful than either of the powerful magnets creating the repulsive force. This is because it is closer to the movable magnet than the fixed magnet is.

Timing. In moving systems, the time at which an object is in a particular location or exerts a particular force is critical. As with positioning, a small force at precisely the right time can have a greater impact on the behavior of the system than a larger force at a different time. Often the principles of timing and positioning can be combined so that a small force of short duration applied at the right time and place can have a large impact on the behavior of the system. When a small force is applied for a short duration, expenditure of energy is minimized. Thus, a minimal expenditure of energy, properly placed and timed, can have a major impact on the system. Timing also is critical with respect to the resonant frequency of a system. Small driving forces, applied at the right time, particularly if each pulse varies across time in precisely the right way, can have a major impact in increasing the oscillations of a system at its resonant frequency.

Selective isolation or intermittent isolation. Selective or intermittent isolation allows for the transfer of energy to or from the environment in an asymmetrical way. The system may be isolated from the environment when a mass is moving in one direction, and connected to something in the environment when the mass is moving in an opposite direction, thus resulting in a net transfer of mechanical energy to or from the environment, producing an asymmetry in the system that can be used to advantage. A hydroelectric power plant is connected to the environment when the water is flowing down, but disconnected from the process wherein the water is raised up again through evaporation.

Lever. A lever has two functions: it transforms a relatively longer motion with a relatively smaller force to a relatively shorter motion with a relatively larger force, or vice versa, and it changes the direction of motion. For example, you can push down 10 inches with a force of 10 pounds on one end of a lever, and the other end of the lever, on the other side of a fulcrum (wherein the fulcrum is closer to the other end) can lift a 100-pound weight one inch upwards.

Mechanical energy-storing mechanism. A mechanical energy-storing mechanism is a device such as a spring, a bow, or a stretchable mechanism, that applies a counterbalancing force when it is displaced from its resting position, wherein the counterbalancing force varies monotonically with the degree to which the mechanism is displaced. For example, a spring can be compressed by fixing one end and applying a force to the other end, with the force in the direction towards the fixed end. As the spring is compressed, the force required to further compress it—and the counterbalancing force it applies in the opposite direction—vary monotonically with the distance to which it is compressed. Throughout the course of its return to its resting position, these two equal and opposite forces vary according to the same pattern in reverse. The spring again applies a force that varies monotonically with the distance to which it is compressed. The same phenomenon takes place with a spring that is stretched, or a stretchable medium such as a rubber band that is stretched. Similarly, a bow applies a counterbalancing force that varies monotonically with the degree to which it is displaced from a straight configuration.

Ratchet. A ratchet is a mechanism that allows motion or rotation in one direction and not in the opposite direction. A ratchet ordinarily comprises a wheel that turns freely in one direction and not in another direction, with teeth that can engage an external object and so as to constrain the motion of the object or the wheel. The same result can be accomplished by a hinge that is flexible in one direction and not in the other direction, such that an object or a protrusion from an object can pass in one direction but not in the other direction. We define such a flexible hinge, when used in this manner, as a type of ratchet.

Resonant frequency. The resonant frequency of a system is the frequency (or frequencies) at which it has a high tendency to oscillate. (With minimal damping, this is approximately the frequency at which the system naturally oscillates.) At a system's resonant frequency, the system stores vibrational energy, so small periodic driving forces can produce large amplitude oscillations.

Machine learning. The invention comprises methods and apparatus for machine learning to empirically determine the optimum parameters and time course of adjustments to the system.

Optimization. The invention comprises methods and apparatus for automatically applying optimum parameters and time course of adjustments to the apparatus so as to optimize its functioning, minimize the expenditure of energy, and maximize the power output of the system.

The present invention combines these features in several novel ways to produce asymmetrical systems that can be used to generate energy.

The prior art in electronics is described in Colman and Seddon-Gillespie (1956), Gray (1975, 1986), Alexander (1975, Inariba (1977), Johnson (1979), Kelly (1979), Spence (1988), Mizutani et al. (1989), Aspden and Adams (1995), Kawai (1995), Correa, Paulo, and Alexandra (1995), Flynn (1995), Hayasaka (1996), Mead and Nachamkin (1996), Ewing (1997), Rakestraw et al. (1997), Masuzawa et al. (1998), Satoh et al. (2000), An (2001), Flynn (2001), Horowitz and Hill (2001), Patrick et al. (2002), Khalaf (2002), Bedini (2002, 2003), Kimura et al. (2002), Kim et al. (2003), Bae (2004), Fecera (2005), Reardon (2005), and Kundel (2006).

The prior art in physics is described in Farwell (1999) and Rapp, Albano, Schmah, & Farwell (1993).

The prior art in mathematics is described in Farwell (1994, 1995a, 1995b, 2010), Farwell et al. (1993), and Rapp et al. (1993).

The present invention applies magnets. Magnets are of two fundamental types: permanent magnets and electromagnets. Electromagnets use electrical energy to generate a magnetic field. Continuous expenditure of electrical energy is required to create and maintain this magnetic field. Electromagnets consume power.

Permanent magnets continuously generate a magnetic field due to their internal structure, and no expenditure of energy is required to maintain this field. Electric generators can use either permanent magnets or electromagnets, or both.

Permanent magnets and electromagnets both work on the principle that a moving or changing electrical field creates a magnetic field. In electromagnets, the changing electrical field is usually generated by running electricity through a coil of electrically conductive material. This requires continuous power, applied from outside the system. In any atom or molecule and any material composed of atoms and molecules, electrons are continuously moving, and each moving electron creates a magnetic field. Generally the motion each electrons is randomly oriented with respect the surrounding electrons, so no external magnetic field is produced. In a permanent magnet, the motions of many electrons are lined up with one another in such a way as to produce an external magnetic field. Thus permanent magnets generate a persistent magnetic field without consuming any power.

Generators using permanent magnets generally convert mechanical energy to electrical energy by moving one or more magnets with respect to one or more coils, or vice versa. When the coil and/or the magnet move in relation to each other, the changing magnetic field of the magnet applied to the coil generates an electrical field in the coil, and as a result current flows through the coil. This electrical energy can then be stored or used. Various methods have been developed to move the coils with respect to the permanent magnets or vice versa by the expenditure of mechanical energy. Usually this is done through rotational motion.

A magnet can move with respect to a coil without the introduction of mechanical energy from outside the system. For example, two magnets oriented so that the north pole of one magnet faces the south pole of another magnet have potential energy by virtue of their magnetic fields and their physical position. This potential energy can be converted to mechanical energy by allowing the magnets to move closer to each other due to the force of attraction between the north pole of one magnet and the south pole of the other magnet.

Such a system can generate electricity as the magnets move closer. For example, one magnet may be fixed, and the other may be allowed to move towards it due to the force of attraction between the north pole of one magnet and the south pole of the other. If a coil is introduced along the path of the moving magnet, electrical energy is generated as the moving magnet moves toward the fixed magnet. The magnetic fields generated by the permanent magnets are not diminished or expended in this process, and with permanent magnets no energy is required to maintain these magnetic fields. Electrical energy has been generated in a system powered by magnetic attraction. The force of magnetic attraction has not been expended or reduced, and no outside energy has been introduced into the system to maintain this force or replenish it.

The difficulty, of course, is that without something added to the system this can only be done once. The potential energy in the initial configuration was a result not only of the magnetic fields, but also of the relative positions of the magnets, and that spatial configuration has changed. Restoring the potential energy inherent in the relative position of the magnets ordinarily will require the expenditure of mechanical energy, since the attractive force of the magnets is opposite to the motion required to separate the magnets and move them back to the initial configuration.

The two requirements for there to be potential energy that can be used to do work are the magnetic fields of the magnets, which do not get expended in the process, and their relative position, i.e., separated by a substantial distance, which does change in the process and ordinarily requires input of mechanical energy to be restored to the initial condition.

Just as a simple system can be constructed to generate electrical energy (once, at a single stroke) with a movable magnet moving toward a fixed magnet when their opposite poles are oriented towards each other, a similar system can be constructed to generate energy when a movable magnet moves away from a fixed magnet due to repulsion. All that is necessary for such a system is that the north poles or south poles of the two magnets face each other. The like poles will repel each other, the movable magnet will be accelerated by this force of repulsion away from the fixed magnet, and electricity can be generated by a coil properly placed along its path.

Here again, the system generates electrical energy without the introduction of energy from outside the system, and without expenditure or diminution of the force of magnetic repulsion that powers that motion. Again, however, this can only be done once without something else added, because the initial potential energy in the system depends on the relative position of the magnets close to each other, and after the electricity is generated they are far apart.

The above systems are complementary. One generates electricity by using magnetic attraction to move a magnet past a coil towards another magnet. The other generates electricity by using magnetic repulsion to move a magnet past a coil away from another magnet. The “approaching” system can be used to restore the initial potential energy inherent in close proximity of the magnets that is required by the “distancing” system. The “distancing” system in turn can restore the initial potential energy that is inherent in the magnets being located at a distance from each other that is required as the initial condition for the approaching system. The same magnets can be used for both systems.

The forces of magnetic attraction and repulsion that power the motion in both directions of the moving magnet exist by virtue of the nature of the magnets, and are not expended when used, nor do they require outside energy input to be maintained or replenished.

A system can be constructed to take advantage of the attraction and repulsion in an alternating fashion. The only energy input that is required in such a system is the energy necessary to reconfigure the moving magnet so the facing poles are opposite as the magnets move closer, and the facing poles are the same as the magnets move apart. That is, if the fixed magnet has its north pole facing the moving magnet, the moving magnet has is south pole facing the fixed magnet as it approaches and its north pole facing the fixed magnet as it moves away.

The present invention comprises efficient and novel methods for reconfiguring the moving magnet to accomplish this reversing of polarity in such a way that substantially less energy is expended in the reconfiguration than is gained in the approaching and receding motions. Thus, even though the system will inevitably be hampered by friction, and the conversion of mechanical energy to electrical energy is less than 100% efficient, the system generates more energy than it consumes.

The major forces in the present invention are produced by the attraction and repulsion of permanent magnets. These magnets do not require energy to continue to maintain their magnetic fields, and the magnetic fields are not consumed or decreased when they are used to generate mechanical energy. The highly efficient reconfiguration of this system is primarily accomplished by placement of smaller, less powerful electromagnets that are powered only for brief moments at the exact right time and place to have the desired effect. This minimizes the power consumption of the system, while leaving intact the major forces responsible for its energy generation.

The invention also comprises additional means to automatically adjust the current passing through the coils that generate the electromagnets to precisely match the pattern in time and space of the magnetic force (or cancellation of an opposite magnetic force) required to maintain the desired motion of the system, and thereby to optimize the system for minimum energy consumption.

Another means of increasing the efficiency of the invention is the use of devices based on all of the above principles, particularly levers, ratchets, and mechanical energy-storing mechanisms, to reverse intermittent forces in the direction opposite to the desired direction of motion of the apparatus. In this way the motion produced by these initially counterproductive forces actually serves in large measure to power the device rather than impeding its function.

In this system, energy is generated by the motion of a magnetic field, which generates an electric field and the resulting current in a conductor. The motion of this magnetic field is produced by mechanical motion powered by the forces of attraction and repulsion of magnets, which are not consumed or diminished in the process. All that is necessary for this to produce a net gain of energy is that the process of reconfiguration consumes substantially less energy than the energy gained by the approaching and receding motions of the magnets. This difference must be substantial enough that it more than compensates for the loss of energy that takes place in the conversion of mechanical energy to electrical energy through the coil and the loss of energy to friction.

In an alternative embodiment, the mechanical energy generated by the system is used to do work directly, without being converted into an electric current.

### OBJECTS OF THE INVENTION

It is, therefore, a general object of the invention to provide a method and apparatus for generating mechanical energy through magnetic attraction and repulsion. It is another general object of the invention to generate electrical energy through converting the mechanical energy so generated to electrical current. It is another general object of the invention to provide a method for reconfiguring the relative position and orientation of pairs of magnets so as to produce an alternating sequence of predominance of forces of attraction and forces of repulsion between magnet pairs. It is another general object of the invention to accomplish this reconfiguration in such a manner as to consume less energy in the reconfiguration than the energy generated by the system, thereby producing a net generation of energy. It is another general purpose of the invention to generate electrical power through the use of fixed and moving magnets without energy input from outside the system.

### SUMMARY OF THE INVENTION

The invention comprises an asymmetrical apparatus that applies the following principles, mechanisms, and features: inherent inexhaustible force, timing, selective or intermittent isolation, the lever, mechanical energy-storing mechanisms, the ratchet, resonant frequency, machine learning, and optimization. The invention combines these principles, mechanisms, and features in a novel way to produce a method and apparatus for generating electrical or mechanical energy through the use of permanent magnets and electromagnets.

The invention comprises the following components:

A freely rotating disk is attached to a relatively stationary platform. The disk is free to rotate in one of two directions. The invention is configured such that one of these directions is productive for the generation of energy. For the below discussion, we shall consider that clockwise is the productive direction.

One or more permanent magnets are fixed to the disk such that their axes are tangential to the disk. (For reasons described below, we refer to these magnets as driven magnets.) These magnets are disk shaped, or of another shape that is relatively wide across the diameter and relatively short along the axis from pole to pole. For the purposes of this discussion we shall assume that these driven magnets are affixed to the disk such that as the disk rotates clockwise, when they are on the right-hand side their south poles are facing downwards with respect to the observer.

One or more permanent magnets are fixed to the same platform. (For reasons described below, we refer to these as driver magnets.) These magnets are cylindrical, or of another shape that is relatively short across its diameter and relatively long along the axis from pole to pole. These driver magnets are mounted radially with respect to the disk, such that one pole faces and is in close proximity to the disk. For the purposes of this discussion we shall assume that this is the north pole. We shall also assume that the driver magnet is below the disk (or in the negative direction on the conventional Y axis) from the perspective of an observer.

As the disk rotates clockwise, as a driven magnet approaches the driver magnet, the south pole of the driven magnet faces the south pole of the driver magnet. This results in attraction between the magnets, which in turn results in acceleration of the disk in a clockwise direction. This configuration we refer to as the attraction zone.

When a driven magnet has passed the driver magnet and is proceeding away from it, the north pole of the driven magnet faces the north pole of the driver magnet. This results in repulsion, which also accelerates the disk in the clockwise direction. This we refer to as the repulsion zone. Together the repulsion zone and the attraction zone constitute the propulsion zone. The configuration and corresponding time that a magnet is in the propulsion zone constitute the propulsion phase.

As the disk rotates, when the driven magnet is in close proximity to the driver magnet, there is a range of angles where the repulsion of the north pole of the driven magnet for the north pole of the driver magnet outweighs the attraction of their opposite poles. This creates a net counterclockwise (and for the purposes of generation of energy counterproductive) force of magnetic repulsion. This force results in deceleration of the disk in its clockwise motion. The range of angles and corresponding relative positions of the magnets wherein this takes place is referred to herein as the resistance zone. The configuration and corresponding time when a driven magnet is in the resistance zone is referred to as the resistance phase.

In order to produce mechanical energy, the disk must continue to rotate in the clockwise direction. To do so, the driven magnet must pass through the resistance zone.

The invention comprises a methodology to reconfigure the apparatus when it is in the resistance zone in such a way that the counterproductive forces, and concomitant deceleration of the disk, are minimised or eliminated. This is accomplished with a minimum of expenditure of energy, such that the energy gained in the propulsion zone is considerably greater than the energy expended in the resistance zone. Some of the excess energy can be captured through well-known electronic or mechanical means. Thus the invention generates energy. This is accomplished as follows.

The system receives electrical power from an intermittent electrical circuit comprising a power source with an electrically negative pole and an electrically positive pole, conductive wires, a continuous connector, and an intermittent connector, such that the circuit will conduct electricity when the apparatus is in some configurations and not conduct electricity in other configurations.

One or more coils of conductive material are intermittently powered by the electrical circuit so as to generate electromagnets.

An intermittent electromagnet is attached either to the rotating disk or to the fixed platform such that when the apparatus is in the resistance zone the electromagnet will be between the north pole of the driven magnet and the north pole of the driver magnet. When, and only when, the apparatus is in the resistance zone, the circuit is closed and a current is routed through the electromagnet. If the electromagnet is attached to the disk, it generates a south pole facing the driver magnet. If the electromagnet is attached to the platform, it generates a south pole facing the driven magnet. In either case, the magnetic field generated by the electromagnet counteracts the magnetic repulsion of the driver and driven magnets while the driven magnet is in the resistance zone.

The voltage applied to the electromagnet, and the corresponding current and magnetic field, are controlled by a control module. The simplest form of the control module simply closes the circuit when the driven disk is in the resistance zone, thus creating the counterbalancing magnetic field, and breaks the circuit when the driven magnet is in the propulsion zone. Closing the circuit reduces or eliminates the counterproductive magnetic repulsion that otherwise would decelerate the disk when in the resistance zone. Breaking the circuit allows the inherent attraction and repulsion of the driver and driven magnets to accelerate the disk in the productive clockwise direction, when the driven magnet is in the attraction and repulsion zones respectively.

In a more sophisticated embodiment, when the driven magnet is in the resistance zone, the control module modulates the voltage and corresponding current and magnetic field generated by the electromagnet such that it varies with the counterproductive repulsion of the driver and driven magnets. This reduces the energy consumed by the apparatus, and thus increases its efficiency.

To modulate that voltage such that it varies with the repulsive magnetic forces while the driven magnet is in the resistance zone, the apparatus further comprises a strain gauge. The driven magnet is attached to the strain gauge, which is attached to the disk. Changes in the repulsive force are sensed by the strain gauge and conveyed to the control module, which modulates the voltage applied to the electromagnet such that it varies monotonically with the repulsive force. In this way the counterbalancing magnetic force is continuously adjusted while the magnet is in the resistance zone to match and counteract the counterproductive repulsive force between the driver and driven permanent magnets.

The invention applies machine learning and optimization methods to optimize the modulation of the voltage and corresponding current and magnetic field of the electromagnet, and thereby to minimise the energy expended while the driven magnet is in the resistance zone. This increases the efficiency of the system in generating energy.

To harness the mechanical energy generated by the apparatus through the rotation of the disk, the invention further comprises one or more coils of conductive material surrounding a core of iron or other magnetic (but not magnetized) material. These generating coils are positioned radially to the disk. As is well understood by those skilled in the art, these coils generate an electric current through the well-known principle of electromagnetic induction. (See, for example, Horowitz and Hill 2001).

When the apparatus generates more energy through the generating coils than it expends in the electromagnets, some of the energy so generated can be fed back into the circuit that powers the electromagnets. Thus the system becomes a self-powering device that produces a net surplus of energy.

The efficiency of the above described electronic embodiments can be further enhanced by the mechanical embodiment of the invention. The mechanical embodiment of the invention further comprises a series of levers and a mechanical energy-storing mechanism that further reduce the expenditure of energy in the resistance phase, and thus increase the efficiency of the apparatus.

When a magnet is in the resistance zone, a counterproductive (counterclockwise) force is produced by the mutual repulsion of the like poles of the driver and driven magnets. This counterproductive force acts to decelerate the disk. The mechanical embodiment of the invention uses a series of interconnected levers to transform some of this counterproductive force applied to the driven magnet into productive force applied by a lever to a post mounted on the disk.

The mechanical embodiment further comprises an energy-storing mechanism such as a spring or a flexible lever. The energy-storing mechanism produces a counterbalancing force that varies with the degree to which it is displaced from its resting position.

One such mechanism is a flexible lever that impinges at one end upon a post attached to the disk. The other end of the flexible lever is attached by a series of levers to the driven magnet, such that displacement of the driven magnet in the counterclockwise (counterproductive) direction with respect to the disk—which takes place due to the counterproductive magnetic repulsion during the resistance phase—produces a bending of the flexible lever that varies monotonically with the displacement. The flexible lever in turn applies a force in the clockwise (productive) direction to the post attached to the disk. In this way some of the counterproductive force of magnetic repulsion during the resistance phase is transformed to into productive force that pushes the disk in the desired direction.

A ratchet allows the post affixed to the disk to pass the flexible bow as the driven magnet approaches the resistance zone, and then allows the flexible bow to connect forcibly with the post and drive the disk in the productive direction.

The efficiency of the mechanical embodiment is further enhanced when the speed of rotation of the disk and/or the configuration of the series of levers is adjusted such that the flexing of the flexible lever takes place at its resonant frequency. The former can be adjusted through a mechanism to impede the rotation of the disk, such as adjusting the distance between the generating coils and the disk. The latter can be accomplished by adjusting the position of the fulcrum of the flexible lever.

The mechanical embodiment can be combined with the previously described electronic embodiments to increase the efficiency thereof.

### BRIEF DESCRIPTION OF THE DRAWINGS

Other objects and advantages of the present invention will become apparent from the following detailed description of preferred embodiments thereof taken in conjunction with the accompanying drawings, wherein:

FIGS. 1a, 1b, 1c, and 2 are schematics that illustrate the basic apparatus, motions, and forces involved in the simplest form of the invention, which involves both fixed and moving permanent magnets. The operation of this form of the invention depends on these components, plus one or more sets of additional components illustrated in FIGS. 3-9.

FIG. 1a is a top view of the apparatus. FIG. 1b is side view of the apparatus, viewed from the right side. FIG. 1c is a front view of the apparatus.

In all figures, positions, motions, and forces are described with reference to the following arbitrary directions: Direction X is toward the right in the top and front views (directly toward the viewer in the side view). Direction −X is toward the left in the top and front views (directly away from the viewer in the side view). Direction Y is toward the top of the figure in the top view and toward the right in the side view (directly away from the viewer in the front view). Direction −Y is toward the bottom of the figure in top view and toward the left in the side view (directly toward the viewer in the front view). Direction Z is toward the top of the figure in the front and side views (directly toward from the viewer in the top view). Direction −Z is toward the bottom of the figure in the front and side views (directly away from the viewer in the top view).

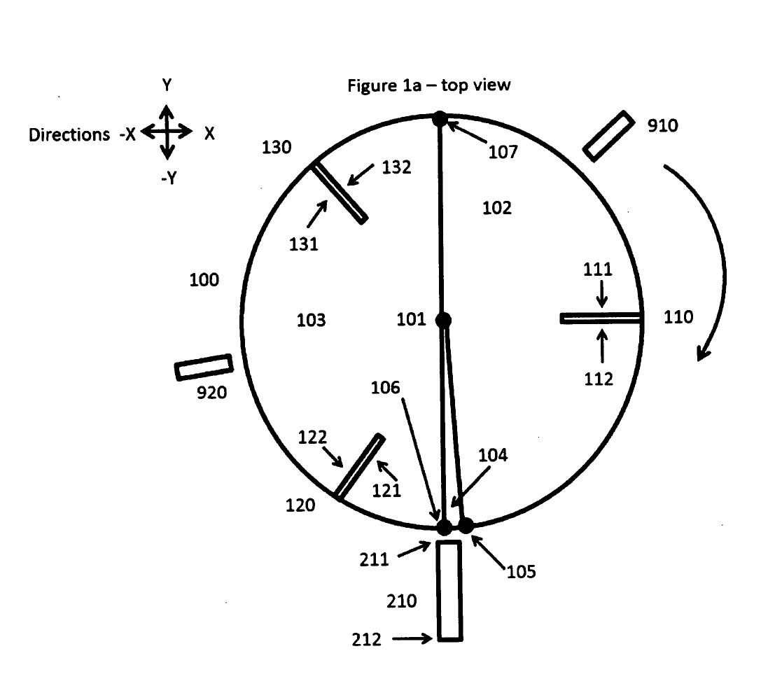

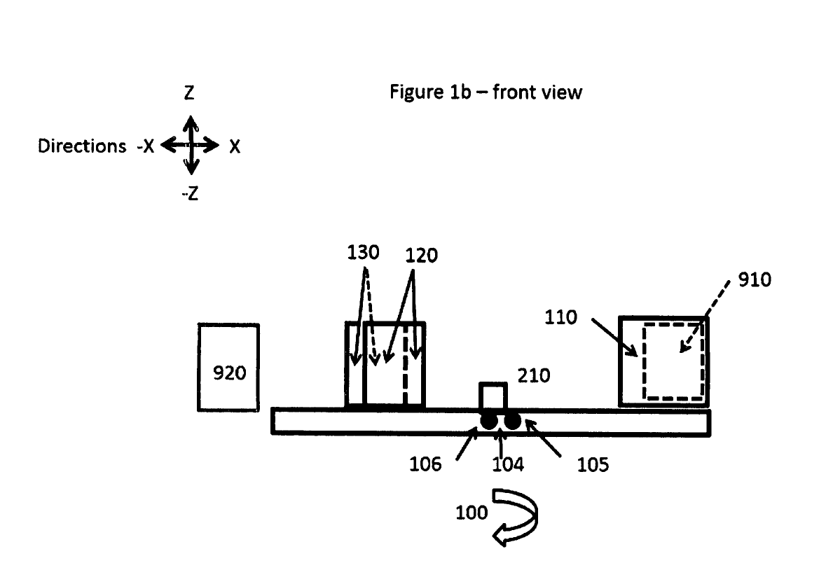

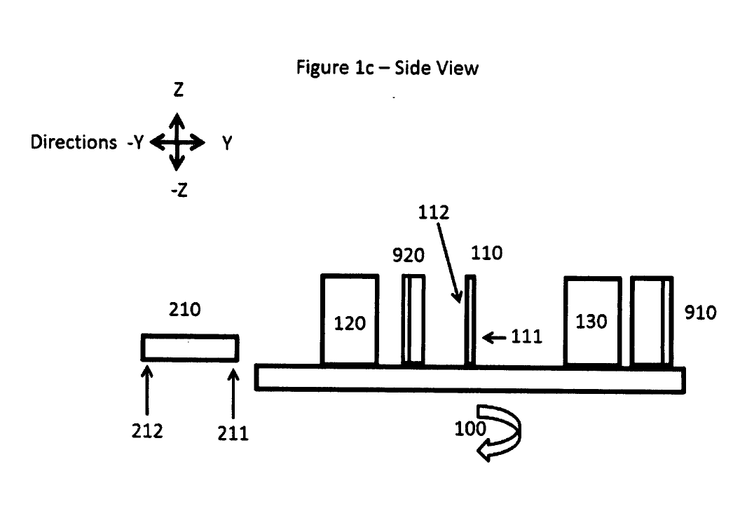

In FIG. 1a, with respect to the driven disk 100, positions, directions, and vector forces can be alternatively described in terms of the following four directions: radial in towards the center, radial out away from the center, tangential (perpendicular to the radius) in a clockwise direction, and tangential counterclockwise.

The invention in FIGS. 1a, 1b, and 1c comprises the following components. A driven disk 100 is fixed at the center point 101 and free to rotate with minimum resistance due to friction. Driven disk 100 is fixed to an immovable platform (not separately illustrated in the figure), such that the disk cannot be displaced, but can rotate freely. Mounted on the driven disk are permanent driven magnets 110, 120, and 130. The driven magnets have respective north poles 111, 121, and 131 and south poles 112, 122, and 132. The driven magnets 110, 120, and 130 are mounted near the edge of the driven disk such that the axis of the north and south poles of the magnet is perpendicular to the radius of the disk, lying in or parallel to the plane of the disk. The driven magnets are relatively short along their north-south axis, and relatively wide across their diameters. The driven magnets 110, 120, and 130 are mounted such that when a magnet is on the right side of the disk in the top view, towards direction X, its north pole is towards the top of the figure in the top view, towards direction Y.

Ordinarily, the platform is fixed with respect to the earth. It may, however, be fixed with respect to a vehicle or other movable object that is relatively large compared to the disk.

In FIGS. 1a, 1b, and 1c the permanent driver magnet 210 is fixed. (It is fixed to an immovable platform, not separately illustrated in the figure, or to the earth). It is mounted close to the outer edge of the driven disk 100, with its axis along the extended radius of the disk. It is relatively long along its axis from its north pole 211 to its south pole 212. It is relatively short across its diameter. Its north pole 211 is close to the edge of driven disk 100. Its south pole 212 is far from driven disk 100.

In FIGS. 1a, 1b, and 1c in conventional terminology, driven magnets 110, 120, and 130 could be called rotor magnets, and driver magnet 210 could be called a stator magnet. In some versions of the invention, however, driver magnets may not be static, but may be mounted on a moving element. To avoid confusion, we use the terms “driver” and “driven” to describe the two types of magnets involved in the present invention, and avoid the terms “rotor” and “stator.” In the preferred embodiment, driver magnet 210 is stronger than driven magnets 110, 120, and 130.

In FIGS. 1a, 1b, and 1c in the preferred embodiment, each of the fixed coils 910 and 920 comprise a coil of electrically conductive wire around an iron core. Alternatively, the coil may surround a core of another magnetic material, or a non-magnetic material.

In FIG. 1a, equilibrium point 105, point of no return 106, and most distant point 107 are on the perimeter of driven disk 100. Point of no return 106 is approximately the closest point on the perimeter of driven disk 100 to the center of driver magnet 210, approximately at the point on driven disk 100 that lies farthest in the −Y direction. Equilibrium point 105 is at approximately five degrees counterclockwise from point of no return 106. Its position will vary depending on the relative strength and positioning of the magnets. Most distant point 107 is at the point on disk 100 at the greatest distance from driver magnet 210, approximately 180 degrees clockwise from point of no return 106.

In FIG. 1a, attraction zone 102 is bounded by the perimeter of driven disk 100 toward direction X and the lines drawn from the center point 101 of driven disk 100 to most distant point 107 and equilibrium point 105. Repulsion zone 103 is bounded by the perimeter of driven disk 100 toward direction −X and lines drawn from the center point 101 of driven disk 100 to the point of no return 106 and the most distant point 107 respectively. The resistance zone 104 is between the attraction zone 102 and the repulsion zone 103, also bounded by the perimeter of driven disk 100 approximately towards direction −Y.

In FIG. 1a, the attraction zone 102 is in the area covered by the driven disk 100 from approximately 180 degrees to approximately 355 degrees clockwise from the radial on the driven disk 100 that points directly towards the center of driver magnet 210. The repulsion zone 103 is from approximately 0 degrees to approximately 180 degrees clockwise from the driver magnet 210. The attraction zone and the repulsion zone together constitute the propulsion zone. The resistance zone 104 is from approximately 355 degrees to 0 degrees (the equivalent of 360 degrees) from the driver magnet 210.

In FIG. 1a, the driven magnet 110 is in the attraction zone, and the driven magnets 120 and 130 are in the repulsion zone. All driven magnets are in the propulsion zone. All driven magnets accelerate the driven disk 100 in a clockwise direction. This is referred to as the propulsion configuration of the apparatus. The time interval when the apparatus is in the propulsion configuration is referred to as the propulsion phase.

In the embodiments of the invention illustrated in FIGS. 1-4, no forces are applied in directions Z and −Z, and no motions take place in these directions. In any case, such forces have no effect on the speed of rotation of driven disk 100, except for possibly a minute increase in friction.

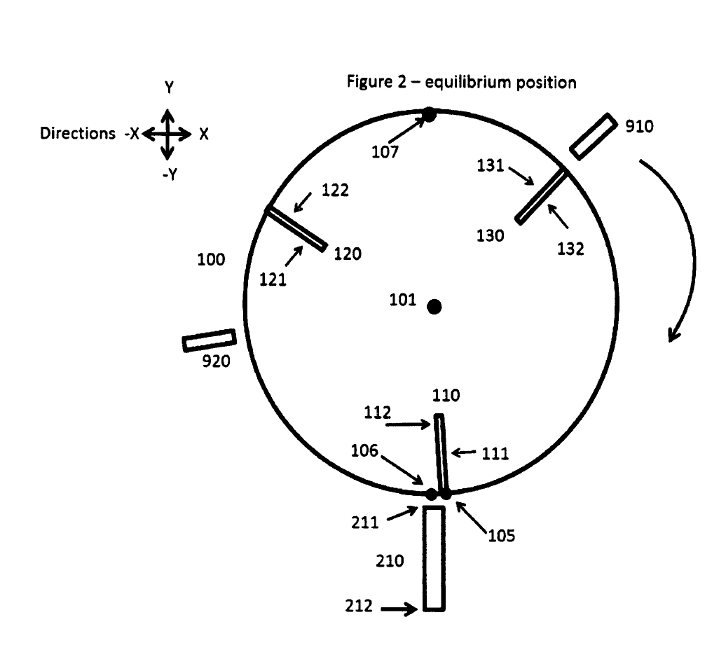

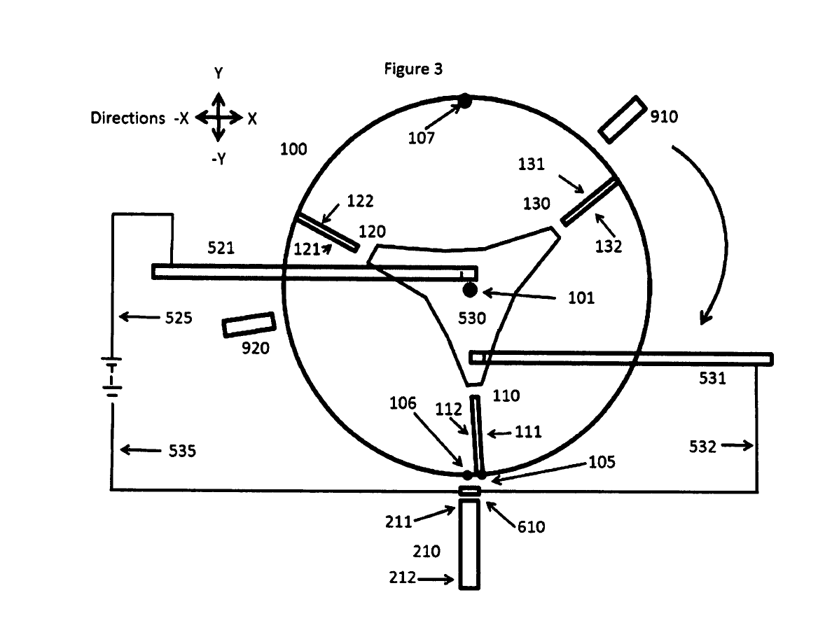

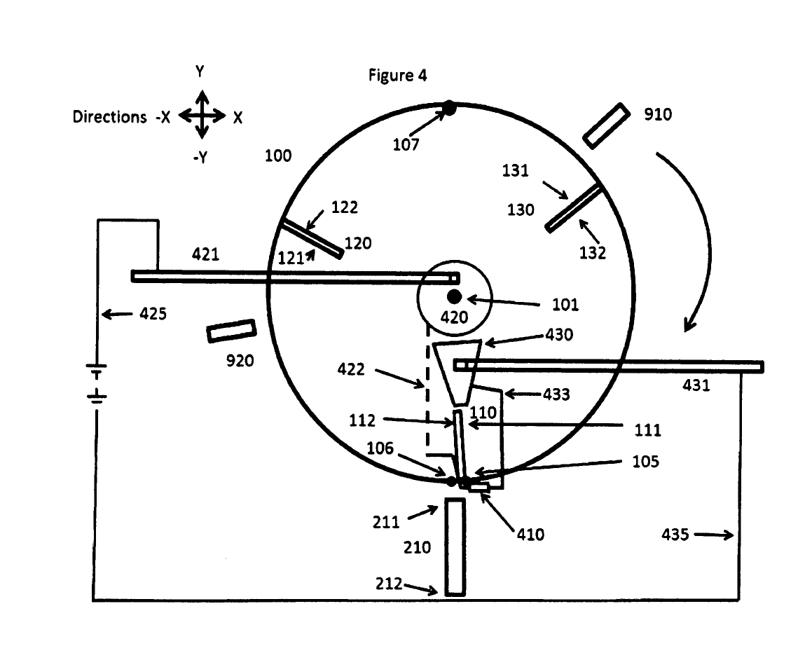

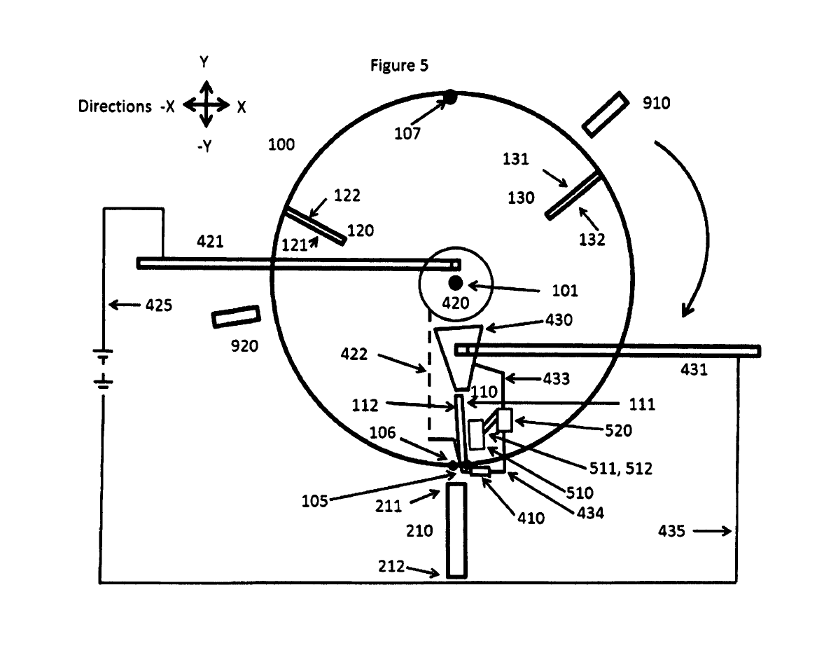

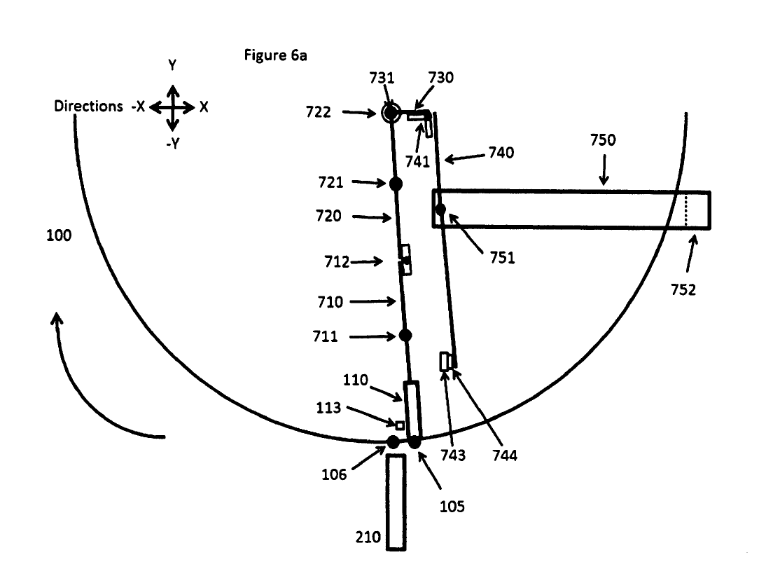

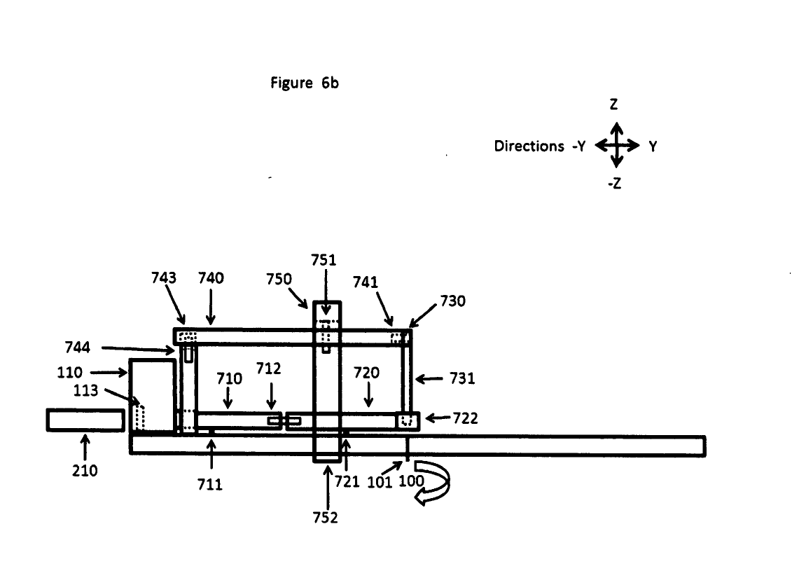

FIG. 2 is a schematic of the same apparatus as FIG. 1a, in a different configuration, namely the equilibrium configuration. In FIG. 2, driven magnet 110 is at the equilibrium point 105.

As in FIG. 1a, driven disk 100 is fixed at the center point 101 and free to rotate with minimum resistance due to friction. Mounted on the driven disk are driven magnets 110, 120, and 130. The driven magnets have respective north poles 111, 121, and 131 and south poles 112, 122, and 132. The driven magnets 110, 120, and 130 are mounted near the edge of the driven disk such that the axis of the north and south poles of the magnet is perpendicular to the radius of the disk, lying in or parallel to the plane of the disk. The driven magnets are relatively short along their north-south axis, and relatively wide across their diameters. The driven magnets 110, 120, and 130 are mounted such that when a magnet is on the right side of the disk in the top view, towards direction X, its north pole is towards the top of the figure in the top view, towards direction Y.

As in FIG. 1a, driver magnet 210 is fixed. It is mounted close to the outer edge of the driven disk 100, with its axis along the extended radius of the disk. It is relatively long along its axis from its north pole 211 to its south pole 212. It is relatively short across its diameter. Its north pole 211 is close to the edge of driven disk 100. Its south pole 212 is far from driven disk 100.

As in FIG. 1a, each of the fixed coils 910 and 920 comprise a coil of electrically conductive wire around an iron core. Alternatively, the coil may surround a core of another magnetic material, or a non-magnetic material.

As in FIG. 1a, equilibrium point 105, point of no return 106, and most distant point 107 are on the perimeter of driven disk 100. Point of no return 106 is approximately the closest point on the perimeter of driven disk 100 to the center of driver magnet 210, approximately at the point on driven disk 100 that lies farthest in the −Y direction. Equilibrium point 105 is at approximately five degrees counterclockwise from point of no return 106. Its position will vary depending on the relative strength and positioning of the magnets. Most distant point 107 is at the point on disk 100 at the greatest distance from driver magnet 210, approximately 180 degrees clockwise from point of no return 106.

Attraction zone 102, repulsion zone 103, and resistance zone 104 are the same as in FIG. 1a, but are not labeled in FIG. 2 for simplicity. As in FIG. 1, these zones are bounded by the perimeter of driven disk 100 and lines drawn from the center 101 of disk 100 to equilibrium point 105, point of no return 106, and most distant point 107. These points are illustrated in both figures.

In FIG. 2, driven magnet 110 is at the equilibrium point 105.

FIG. 3 is a schematic of the fixed pulsed coil embodiment of the invention. This comprises the same apparatus as FIGS. 1a and 2, with one set of additional components.

As in FIGS. 1a and 2, driven disk 100 is fixed at the center point 101 and free to rotate with minimum resistance due to friction. Mounted on the driven disk are driven magnets 110, 120, and 130. The driven magnets have respective north poles 111, 121, and 131 and south poles 112, 122, and 132. The driven magnets 110, 120, and 130 are mounted near the edge of the driven disk such that the axis of the north and south poles of the magnet is perpendicular to the radius of the disk, lying in or parallel to the plane of the disk. The driven magnets are relatively short along their north-south axis, and relatively wide across their diameters. The driven magnets 110, 120, and 130 are mounted such that when a magnet is on the right side of the disk in the top view, towards direction X, its north pole is towards the top of the figure in the top view, towards direction Y.

As in FIGS. 1a and 2, the driver magnet 210 is fixed. It is mounted close to the outer edge of the driven disk 100, with its axis along the extended radius of the disk. It is relatively long along its axis from its north pole 211 to its south pole 212. It is relatively short across its diameter. Its north pole 211 is close to the edge of driven disk 100. Its south pole 212 is far from driven disk 100.

As in FIGS. 1a and 2, each of the fixed coils 910 and 920 comprise a coil of electrically conductive wire around an iron core. Alternatively, the coil may surround a core of another magnetic material, or a non-magnetic material.

As in FIGS. 1a and 2, equilibrium point 105, point of no return 106, and most distant point 107 are on the perimeter of driven disk 100. Point of no return 106 is approximately the closest point on the perimeter of driven disk 100 to the center of driver magnet 210, approximately at the point on driven disk 100 that lies farthest in the −Y direction. Equilibrium point 105 is at approximately 355 degrees clockwise from point of no return 106. Most distant point 107 is at the point on disk 100 at the greatest distance from driver magnet 210, approximately 180 degrees clockwise from point of no return 106.

Attraction zone 102, repulsion zone 103, and resistance zone 104 are the same as in FIG. 1a, but are not labeled in FIG. 3 for simplicity. As in FIG. 1, these zones are bounded by the perimeter of driven disk 100 and lines drawn from the center 101 of disk 100 to equilibrium point 105, point of no return 106, and most distant point 107. These points are illustrated in both figures.

In FIG. 3, driven magnet 110 is at the equilibrium point 105.

FIG. 3 includes the following components of the fixed pulsed coil embodiment, in addition to the components included in FIGS. 1a and 2.

Fixed insulated wire coil 610 is fixed in the gap between driver magnet 210 and driven disk 100. A voltage is applied to this coil only when driven magnet 110 is in the resistance zone.

Conductive plate 530 is affixed to driven disk 100. Driven disk 100 is made of non-conductive material. Plate 530 surrounds the center of driven disk 100 extending outwards a small fraction of the radius in all directions. It extends farther along the radius toward each of driven magnets 110, 120, and 130. The arm of plate 530 extending toward driven magnet 110 is wider near the center of driven disk 100, and tapers nearer driven magnet 110. The same applies for the arms near driven disks 120 and 130. Conductive movable brush 531 has bristles at the end towards driven disk 100. Movable brush 531 makes contact with plate 530 only when driven disk 110 is approximately in the resistance zone. Movable brush 531 is connected by conductive wire 532 to one end of coil 610. The other end of coil 610 is connected by conductive wire 525 to a negative voltage source.

Conductive fixed brush 521 has bristles at the end toward driven disk 100. Fixed brush 521 makes contact with plate 520 continuously. Fixed brush 521 is connected to a positive voltage source by conductive wire 525.

FIG. 4 is a schematic of the moving pulsed coil embodiment of the invention. This comprises the same apparatus as FIGS. 1a and 2, with alternative additional components, some of which are different from the additional components illustrated in FIG. 3.

As in FIGS. 1a and 2, driven disk 100 is fixed at the center point 101 and free to rotate with minimum resistance due to friction. Mounted on the driven disk are driven magnets 110, 120, and 130. The driven magnets have respective north poles 111, 121, and 131 and south poles 112, 122, and 132. The driven magnets 110, 120, and 130 are mounted near the edge of the driven disk such that the axis of the north and south poles of the magnet is perpendicular to the radius of the disk, lying in or parallel to the plane of the disk. The driven magnets are relatively short along their north-south axis, and relatively wide across their diameters. The driven magnets 110, 120, and 130 are mounted such that when a magnet is on the right side of the disk in the top view, towards direction X, its north pole is towards the top of the figure in the top view, towards direction Y.

As in FIGS. 1a and 2, the driver magnet 210 is fixed. It is mounted close to the outer edge of the driven disk 100, with its axis along the extended radius of the disk. It is relatively long along its axis from its north pole 211 to its south pole 212. It is relatively short across its diameter. Its north pole 211 is close to the edge of driven disk 100. Its south pole 212 is far from driven disk 100.

As in FIGS. 1a and 2, each of the fixed coils 910 and 920 comprise a coil of electrically conductive wire around an iron core. Alternatively, the coil may surround a core of another magnetic material, or a non-magnetic material.

As in FIGS. 1a and 2, equilibrium point 105, point of no return 106, and most distant point 107 are on the perimeter of driven disk 100. Point of no return 106 is approximately the closest point on the perimeter of driven disk 100 to the center of driver magnet 210, approximately at the point on driven disk 100 that lies farthest in the −Y direction. Equilibrium point 105 is at approximately 355 degrees clockwise from point of no return 106. Most distant point 107 is at the point on disk 100 at the greatest distance from driver magnet 210, approximately 180 degrees clockwise from point of no return 106.

Attraction zone 102, repulsion zone 103, and resistance zone 104 are the same as in FIG. 1, but are not labeled in FIG. 4 for simplicity. As in FIG. 1, these zones are bounded by the perimeter of driven disk 100 and lines drawn from the center 101 of disk 100 to equilibrium point 105, point of no return 106, and most distant point 107. These points are illustrated in both figures.

The moving pulsed coil embodiment of the invention illustrated in FIG. 4 includes the following components not included in FIGS. 1 and 2.

In the moving pulsed coil embodiment, a coil 410 of wire is attached to the moving driven disk 100. Coil 410 is situated such that it will be between the north pole 111 of driven magnet 110 and the north pole 211 of driver magnet 210 when the driven magnet 110 is in the resistance zone.

Conductive plate 420 is fixed around the center of driven disk 100. Conductive fixed brush 421 has bristles on the end toward driven disk 100. Fixed brush 421 makes continuous contact with plate 420. Fixed brush 421 is connected to a positive voltage source. Plate 420 is connected by conductive insulated wire 422 to one end of coil 410.

Conductive plate 430 is affixed to driven disk 100 along the radius toward driven magnet 110. Plate 430 is wider near the center of driven disk 100, and tapers nearer driven magnet 110. Conductive movable brush 431 makes contact with plate 430 only approximately when driven magnet 110 is in the resistance zone. Movable brush 431 is connected by insulated wire 433 to one end of coil 410 (the end that is not connected to wire 422). Fixed brush 421 is connected to a positive voltage source. Movable brush 431 is connected to a negative voltage source.

Conductive wire 422 connects to plate 420, travels underneath driven disk 100, and surfaces near coil 410, so that there is no contact between wire 422 and movable brush 431.

A similar plate, wires, and coil are affixed to driven disk 100 in the same configuration with respect to each of driven magnets 120 and 130 as the configuration described above for driven magnet 110. (These are not shown in the drawing, for the sake of simplicity.)

FIG. 5 is a schematic of the moving modulated coil with optimization embodiment of the invention. This comprises the same apparatus as FIG. 4, with additional components.

As in FIGS. 1a, 2, and 4, driven disk 100 is fixed at the center point 101 and free to rotate with minimum resistance due to friction. Mounted on the driven disk are driven magnets 110, 120, and 130. The driven magnets have respective north poles 111, 121, and 131 and south poles 112, 122, and 132. The driven magnets 110, 120, and 130 are mounted near the edge of the driven disk such that the axis of the north and south poles of the magnet is perpendicular to the radius of the disk, lying in or parallel to the plane of the disk. The driven magnets are relatively short along their north-south axis, and relatively wide across their diameters. The driven magnets 110, 120, and 130 are mounted such that when a magnet is on the right side of the disk in the top view, towards direction X, its north pole is towards the top of the figure in the top view, towards direction Y.

As in FIGS. 1a, 2, and 4, the driver magnet 210 is fixed. It is mounted close to the outer edge of the driven disk 100, with its axis along the extended radius of the disk. It is relatively long along its axis from its north pole 211 to its south pole 212. It is relatively short across its diameter. Its north pole 211 is close to the edge of driven disk 100. Its south pole 212 is far from driven disk 100.

As in FIGS. 1a, 2, and 4, each of the fixed coils 910 and 920 comprise a coil of electrically conductive wire around an iron core. Alternatively, the coil may surround a core of another magnetic material, or a non-magnetic material.

As in FIGS. 1a, 2, and 4, equilibrium point 105, point of no return 106, and most distant point 107 are on the perimeter of driven disk 100. Point of no return 106 is approximately the closest point on the perimeter of driven disk 100 to the center of driver magnet 210, approximately at the point on driven disk 100 that lies farthest in the −Y direction. Equilibrium point 105 is at approximately 355 degrees clockwise from point of no return 106. Most distant point 107 is at the point on disk 100 at the greatest distance from driver magnet 210, approximately 180 degrees clockwise from point of no return 106.

Attraction zone 102, repulsion zone 103, and resistance zone 104 are the same as in FIG. 1, but are not labeled in FIG. 5 for simplicity. As in FIG. 1, these zones are bounded by the perimeter of driven disk 100 and lines drawn from the center 101 of disk 100 to equilibrium point 105, point of no return 106, and most distant point 107. These points are illustrated in both figures.

The moving modulated coil with optimization embodiment of the invention illustrated in FIG. 5 includes the following components included in FIG. 4 but not included in FIGS. 1 and 2.

A coil 410 of conductive wire is attached to rotating disk 100. Coil 410 is situated such that it will be between the north pole 111 of driven magnet 110 and the north pole 211 of driver magnet 210 when the driven magnet 110 is in the resistance zone.

Plate 420 is fixed around the center of driven disk 100. Fixed brush 421 has bristles on the end toward driven disk 100. Fixed brush 421 makes continuous contact with plate 420. Fixed brush 421 is connected to a positive voltage source. Plate 420 is connected by an insulated wire 422 to one end of coil 410.

Plate 430 is affixed to driven disk 100 along the radius toward driven magnet 110. Plate 430 is wider near the center of driven disk 100, and tapers nearer driven magnet 110. Movable brush 431 makes contact with plate 430 only approximately when driven magnet 110 is in the resistance zone. Plate 430 is connected by insulated wire 433 to one end of coil 410 (the end that is not connected to wire 422). Fixed brush 421 is connected to a positive voltage source by wire 425. Movable brush 431 is connected to a negative voltage source by wire 435.

Wire 422 travels underneath driven disk 100 and surfaces near coil 410, so that there is no contact between wire 422 and movable brush 431.

The moving modulated coil with optimization embodiment of the invention illustrated in FIG. 5 includes the following components not included in FIG. 4.

Strain gauge 510 is mounted to disk 100. Driven magnet 110 is mounted to strain gauge 510, and not attached directly to disk 100. Strain gauge 510 is connected by wires 511 and 512 to control module 520. Control module 520 is connected to plate 430 by wire 433. Control module 520 is connected by wire 434 to one end of coil 410 (the end not connected to wire 422).

A similar plate, wires, coil, strain gauge, and control module are affixed to driven disk 100 in the same configuration with respect to each of driven magnets 120 and 130 as the configuration described above for driven magnet 110. (These are not shown in the drawing, for the sake of simplicity.)

FIGS. 6a and 6b are schematics of the “mechanical” embodiment of the invention. This comprises the same apparatus as FIG. 1, with additional components. FIG. 6a is a top view of the “mechanical” embodiment of the invention. FIG. 6b is a side view of the “mechanical” embodiment of the invention.

In FIGS. 6a and 6b, driven disk 100, driven magnet 110, driver magnet 210, point of no return 106, equilibrium point 105, and center point 101 are the same as in FIG. 1a. The other components illustrated in FIGS. 1a and 2 are present, but are not shown here for the sake of simplicity.

In FIGS. 6a and 6b, as in the other embodiments, driven disk 100 is fixed at a center point and rotates freely, and driver magnet 210 is fixed. Unlike the other embodiments, driven magnet 110 is not fixed with respect to driven disk 100. Driven magnet 110 is attached rigidly to rigid lever 710. Rigid lever 710 is attached to driven disk 100 at fulcrum 711 such that its point of attachment cannot move with respect to driven disk 100, yet it is free to rotate about this point. Rigid lever 710 is attached to rigid lever 720 by hinge 712. Rigid lever 720 is attached to driven disk 100 at fulcrum 721, like rigid lever 710, such that its point of attachment cannot move with respect to driven disk 100, yet it is free to rotate about this point. The attachments between rigid lever 720 and hinge 712 and between rigid lever 720 and hinge 712 allow said rigid levers to move slightly radially with respect to said hinge, in order to accommodate the increased distance that must be spanned when rigid lever 710 rotates to a limited degree counterclockwise and rigid lever 720 rotates to a limited degree clockwise.

In FIGS. 6a and 6b, loop 722 surrounds cylinder 731. Counterclockwise motion of driven magnet 110 with respect to driven disk 100, which in the illustrated configuration constitutes lateral motion of driven magnet 110 in the X direction, is translated through this mechanism to lateral motion of cylinder 731 in the X direction.

In FIGS. 6a and 6b, cylinder 731 extends upwards from driven disk 100, in the Z direction, to rigid bar 730. Cylinder 731 is fixed with respect to rigid bar 730. Rigid bar 730 is attached by hinge 741 to flexible lever 740.

In FIGS. 6a and 6b, flexible lever 740 can be bent by the application of a force, and will apply an equal and opposite force as it is bent and as it returns to a straight line configuration. The deviation of the flexible lever from a straight line varies directly with the force applied to produce said deviation and the counterbalancing force applied by the flexible lever. The flexible lever functions as an energy-storing mechanism, similar to the functioning of a spring or a springboard. That is, the equation for the force required to bend the flexible lever is the same (in reverse) as the equation for the force returned when the flexible lever returns to a straight line shape.

In FIGS. 6a and 6b, flexible lever 740 is attached at fulcrum 751 to fixed horizontal bar 750 such that its point of attachment cannot move with respect to fixed horizontal bar 750, yet it is free to rotate about this point. Fixed horizontal bar 750 is attached rigidly to fixed post 752, which is attached rigidly to an immovable platform (not illustrated) or to the earth.

In FIGS. 6a and 6b, post 113 is fixed to driven disk 100, such that driven magnet 110 cannot move with respect to driven disk 100 any farther in the clockwise direction (−X direction in this configuration) than the point at which said post is fixed.

In FIGS. 6a and 6b, spring-hinged ratchet post 743 is fixed to driven disk 100. It extends vertically to the approximately the same height as flexible lever 740. Spring hinge 744 is attached near the top of spring-hinged ratchet post 743, on the counterclockwise side (X in the illustrated configuration). Spring hinge 744 allows the top part of spring-hinged ratchet post 743 to be displaced by an object (such as flexible lever 740) that is moving in a counterclockwise direction with respect to driven disk 100 with the application of a very small force.

In FIGS. 6a and 6b, when no force is applied in a counterclockwise direction with respect to disk 100, spring hinge 744 will maintain spring-hinged ratchet post 743 in a vertical configuration throughout its entire height, or return it quickly to vertical if it has been displaced. When a force is applied to the top part of spring-hinged ratchet post 743 in a clockwise direction with respect to driven disk 100 (−X in the configuration illustrated), spring hinge 744 does not move, and spring-hinged ratchet post 743 remains vertical throughout its full height.

In FIGS. 6a and 6b, the force required to bend spring hinge 744 is a very small fraction of the force required to bend flexible lever 740.

In FIGS. 6a and 6b, thus, spring-hinged ratchet post 743 functions as a ratchet to allow motion of flexible lever 740 in the clockwise direction but not in the counterclockwise direction with respect to driven disk 100. A force applied to the top part of spring-hinged ratchet post 743 in the clockwise direction (such as by flexible lever 740) will be fully conveyed to driven disk 100. A force applied to the top part of spring-hinged ratchet post 743 in the counterclockwise direction will not be conveyed to driven disk 100 (except for a force equal to the very small force required to bend spring hinge 744).

In FIGS. 6a and 6b, all of the components that are attached to driven disk 100 in conjunction with driven magnet 110 are replicated in conjunction with driven disks 120 and 130. (These are not illustrated for the sake of simplicity.) These components include everything between driven magnet 110 and loop 722, as well as post 113 and spring-hinged ratchet post 743. The components that are attached to the earth (or the immovable platform) are not replicated if driver magnet 210 is the only driver magnet. These include everything between cylinder 731 and fixed post 752. If there are additional driver magnets, then these components are replicated for each driver magnet.

### DETAILED DESCRIPTION

The invention is powered by the attraction and repulsion of permanent magnets.

In FIG. 1a, the driven magnet 110 is in the attraction zone, and the driven magnets 120 and 130 are in the repulsion zone. All driven magnets are in the propulsion zone.

Referring to driver magnet 210 and driven magnet 110, the forces between the magnets are as follows:
Attraction between the north pole 211 of the driver magnet 210 and the south pole 112 of the driven magnet 110.
Repulsion between the north pole 211 of the driver magnet 210 and the north pole 111 of the driven magnet 110.
Attraction between the south pole 212 of the driver magnet 210 and the north pole 111 of the driven magnet 210.
Repulsion between the south pole 212 of the driver magnet 210 and the south pole 112 of the driven magnet 110.

The attraction and repulsion involving the south pole 212 of the driver magnet 210 are extremely small, because the south pole 212 is far from the driven magnet 110, and the north pole 211 of the driver magnet 210 is much closer to driven magnet 110. For practical purposes, the driver magnet 210 can be considered to consist of only a strong north pole 211 positioned close to the driven disk 100.

In this position, the repulsion of the north pole 111 of the driven magnet 110 for the south pole 212 of the driver magnet 210 is smaller than the attraction of the south pole 112 of this same driven magnet 110 for the same north pole 211 of the same driver magnet 210. At this position, the only effect of this repulsion will be to reduce the net attraction between the two magnets. The attraction between the south pole 112 of the driven magnet 110 and the north pole 211 of the driver magnet 210 will predominate.

The predominant force on the driven magnet 110 in FIG. 1, then, is attraction towards driver magnet 210. Driven magnet 110 is in the attraction zone. The predominant force on driven magnet 110 at any point in the attraction zone will be attraction towards the driver magnet 210. In absolute direction, this force is comprised of two vectors, one toward direction −X and one toward direction −Y. In radial terms, the attraction consists of a tangential vector and a radial vector. The tangential vector accelerates the driven magnet 110 in a clockwise tangential direction, and thus accelerates the driven disk 100 to which it is affixed in a clockwise direction. The radial vector applies force to the fixed center point, and has no effect on the rotational motion of the disk.

Throughout the attraction zone, the predominant force on driven magnet 110 is the attraction of the south pole 112 of the driven magnet 110 for the north pole 211 of the driver magnet 210. The driver magnet 210 is fixed to the earth on a fixed platform. The earth, due to its large mass, is effectively immovable. Thus, throughout the attraction zone the driven magnet 110 and the driven disk 100 to which it is attached accelerate. Driven magnet 110 accelerates in clockwise tangential motion. Driven disk 100 accelerates in clockwise angular motion. The acceleration is angular acceleration of the driven disk 100. The acceleration will depend on the forces applied and the mass of the driven disk 100 along with everything attached to it.

Throughout the attraction zone, the force applied by the driver magnet 210 to the driven magnet 110 accelerates the tangential motion of the driven magnet 110 and increases the corresponding angular velocity of the driven disk 100 to which it is attached.

Driven disks 120 and 130 are in the repulsion zone 103. The predominant and only significant force on them is the net repulsion between their south poles 122 and 132 respectively and the north pole 221 of the driver magnet 220. Thus, both of these also accelerate away from the driver magnet 220, and both contribute to the angular velocity of the driven disk 100 in the clockwise direction.

In FIG. 1a, all three driven magnets 110, 120, and 130 are in the propulsion zone. All magnets in the propulsion zone apply a clockwise force that accelerates the angular motion of the driven disk 100. This configuration can thus be described as the acceleration configuration or the propulsion configuration.

In the embodiments of the invention illustrated in FIGS. 1-5, no forces are applied in directions Z and −Z. In any case, such forces have no effect on the speed of rotation of driven disk 100, except for possibly a minute increase in friction.

FIG. 2 is a schematic of the same apparatus in the equilibrium configuration. Driven magnet 110 is at the equilibrium point. The major forces on driven magnet 110 that affect the angular velocity of driven disk 100 are as follows. (Herein we shall use “torque” to be synonymous with “moment of force,” whether the resultant of the applied force vectors is 0 or not.)

### Clockwise Torque:

1. The tangential vector of the attraction between the south pole 112 of driven magnet 110 and the north pole 211 of driver magnet 210 constitutes a clockwise torque on the driven disk 110.
2. The tangential vector of the net force of repulsion between driver magnet 210 and driven magnet 120 constitutes a clockwise torque on the driven disk 110.
3. The tangential vector of the net force of attraction between driver magnet 210 and driven magnet 130 constitutes a clockwise torque on the driven disk 110.

### Counterclockwise Torque:

1. The tangential vector of the repulsion between the north pole 111 of driven magnet 110 and the north pole of driver magnet 210 constitutes a counterclockwise torque on the driven disk 110. Throughout most of the course of driven disk 110 moving through the attraction zone, this force is overwhelmed by the force of attraction between the south pole 112 of driven magnet 110 and the north pole 211 of driver magnet 210. This is because the north pole 111 of driven magnet 110 is farther away from driver disk 210 than the south pole 112 of driven magnet 110 is. When the 2 disks are in close proximity, and the angle of the driven disk 110 has changed to expose its north pole 111 to the north pole 211 of driver disk 210, this repulsive force is no longer trivial.

As driven magnet 110 closely approaches the north pole 211 of driver magnet 210, the counterclockwise torque increases rapidly. At a point where driven magnet 110 is quite close to driver magnet 210, the total counterclockwise forces are equal to the total clockwise forces. This is the equilibrium point 105. When one magnet is at the equilibrium point, the apparatus is in a state of equilibrium, and no motion will be initiated. If left to move freely with no additional intervention, the apparatus will come to rest with driven magnet 110 (or another driven magnet) at the equilibrium point 105.

In order to rotate driven disk 110 clockwise when driven magnet 110 is at the equilibrium point, a clockwise torque must be applied, or some other change must be made to the apparatus.

If a sufficient clockwise torque is applied to driven disk 100 when driven magnet 110 is in the equilibrium point, and the force is maintained across some distance, the disk rotates clockwise and driven disk 110 moves across driver magnet 210. This is the resistance configuration of the apparatus, because the net combined torque of the magnets opposes clockwise motion. The time during which the apparatus is in the resistance configuration constitutes the resistance phase of the apparatus.

In moving magnet 110 clockwise from the equilibrium point 105, the following 2 significant changes in the configuration take place.
1. The angular orientation of driven disk 110 with respect to driver disk 210 changes such that the distance from the north pole 111 of driven disk 110 to the north pole 211 of driver disk 210 is less than the distance from the south pole 112 of driven disk 110 to the north pole of driver disk 210. This produces a net repulsion between driver disk 210 and driven disk 110.
2. Driven disk 110 moves to the other (direction −X) side of driver disk 210, so now repulsion between driver magnet 210 and driven magnet 110 produces a clockwise torque on driven disk 110.

Due to these changes, as the clockwise motion continues, a point is soon reached where the clockwise torque is greater than the counterclockwise torque. This is the point of no return 106. It is approximately at the point where driven magnet 110 is closest to the center of driver magnet 210. When driven magnet 110 passes the point of no return 106, the apparatus is no longer in the resistance configuration. It resumes the propulsion configuration until another magnet (in this case, driven magnet 120) reaches the equilibrium position 105.

Throughout all angles when the apparatus is in the propulsion configuration, the magnetic attraction and repulsion of the components produce torque, acceleration, angular momentum, kinetic energy, and mechanical energy.

This mechanical energy can readily be converted to electrical energy. In the preferred embodiment, this is accomplished by positioning one or more fixed coils near the perimeter of driven disk 110. Each of coils 910 and 920 comprises copper wire wound around an iron core. Alternatively, the coils may be wound around a different magnetic substance, or a non-metallic or non-magnetic core. As the magnets pass by the coil, first approaching and then receding, they generate an electrical voltage and corresponding current.

The iron core of coils 910 and 920 is attracted equally to the north and south poles of the driven magnets 110, 120, and 130. While a driven magnet is approaching a coil, this attraction accelerates the disk 100. When a driven magnet has passed a coil and is moving away from it, this attraction decelerates the disk by an approximately equal amount. Thus the net effect of the coils on the rotation of the disk is minimal. This allows for efficient use of the mechanical energy of the rotating disk in generating electricity through the coils.

A purpose of the invention is to generate energy. Energy is generated throughout the time the apparatus is in the propulsion configuration. Energy is consumed during the resistance phase, the relatively small proportion of time that the apparatus is in the resistance configuration.

Mechanical energy is gained during the propulsion phase as the rotational velocity of disk 100 increases. To keep the apparatus moving, energy must be expended during the resistance phase. In order to produce a net power output, the invention applies several methods to periodically reconfigure the apparatus so as to reduce the energy consumed in the resistance phase, while substantially maintaining the propulsion phase. This reconfiguration is accomplished with a minimum consumption of power. The invention comprises several methods to accomplish this periodic reconfiguration. The various methods reconfigure the apparatus so as to reduce or eliminate the counterclockwise forces during the resistance phase, while consuming a minimum of energy in so doing.

FIG. 3 is a schematic of the fixed pulsed coil embodiment, a method and apparatus to generate energy by maintaining the forces that drive the propulsion phase and minimizing the energy consumed during the resistance phase by reducing or eliminating the counterclockwise forces during that phase with a minimum expenditure of energy.

The fixed pulsed coil embodiment comprises mounting a fixed insulated wire coil 610 in the gap between driver magnet 210 and driven disk 100, and applying a voltage to this coil only when driven magnet 110 is in the resistance zone. Sufficient voltage is applied to create a magnetic force opposite to the polarity of driver magnet 210, in effect cancelling the magnetic force applied by driver magnet 210 to driven magnet 110 for the time that driven magnet 110 is in the resistance zone. The kinetic energy accumulated in the propulsion phase moves driven magnet 110 through the resistance zone. Then the voltage to the coil is stopped as driven magnet 110 moves into the propulsion zone. At this point the magnetic force of driver magnet 210 resumes, and the repulsion between driver magnet 210 and driven magnet 110 drives the latter in a clockwise direction.

In the fixed pulsed coil embodiment, the timing of the voltage pulses is accomplished by the following system. Plate 530 is affixed to driven disk 100. It surrounds the center of driven disk 100 extending outwards a small fraction of the radius in all directions. It extends farther along the radius toward each of driven magnets 110, 120, and 130. The arm of plate 530 extending toward driven magnet 110 is wider near the center of driven disk 100, and tapers nearer driven magnet 110. The same applies for the arms near driven disks 120 and 130. Movable brush 531 has bristles at the end towards driven disk 100. Movable brush 531 makes contact with plate 530 only when driven disk 110 is approximately in the resistance zone. Movable brush 531 is connected by insulated wire 532 to one end of coil 610. The other end of coil 610 is connected to a negative voltage source by wire 535.

Fixed brush 521 has bristles at the end toward driven disk 100. Fixed brush 521 makes contact with plate 520 continuously. Fixed brush 521 is connected to a positive voltage source.

When driven magnet 110 is in the resistance zone, an electric circuit is formed, current flows through coil 410, and a magnetic field opposite to the north magnetic field of driver magnet 210 is produced between driver magnet 210 and driven magnet 110. This in effect eliminates the repulsion between the north pole 211 of driver magnet 210 and the north pole 111 of driven magnet 110. This allows driven magnet 110 to move through the resistance zone with dramatically reduced resistance.

The operation of the invention can be fine tuned by moving movable brush 531 closer to or farther from the center of driven disk 110. When the disk is spinning at high velocity, energy consumption can be minimized by moving brush 531 outward, where it will be in contact with plate 530 for less time, not only in absolute terms but also as a percentage of the total time elapsed per revolution.

The moving pulsed coil embodiment comprises an even more efficient method and apparatus, illustrated in FIG. 4. A coil 410 of wire is placed on the moving driven disk 110. A coil 410 is situated between the north pole 111 of driven magnet 110 and the north pole 211 of driver magnet 210.

In the moving pulsed coil embodiment, the timing of the voltage pulses is accomplished by the following system. Plate 420 is fixed around the center of driven disk 100. Fixed brush 421 has bristles on the end toward driven disk 100. Fixed brush 421 makes continuous contact with plate 420. Fixed brush 421 is connected to a positive voltage source. Plate 420 is connected by an insulated wire 422 to one end of coil 410.

Plate 430 is affixed to driven disk 100 along the radius toward driven magnet 110. Plate 430 is wider near the center of driven disk 100, and tapers nearer driven magnet 110. Movable brush 431 makes contact with plate 430 only approximately when driven magnet 110 is in the resistance zone. Plate 430 is connected by insulated wire 433 to one end of coil 410 (the end that is not connected to wire 422). Fixed brush 421 is connected to a positive voltage source. Movable brush 431 is connected to a negative voltage source.

Wire 422 travels underneath driven disk 100 and surfaces near coil 410, so that there is no contact between wire 422 and movable brush 431.

A similar plate, wires, and coil are affixed to driven disk 100 in the same configuration with respect to each of driven magnets 120 and 130 as the configuration described above for driven magnet 110. (These are not shown in the drawing, for the sake of simplicity.)

When driven magnet 110 is approximately in the resistance zone, an electric circuit is formed, current flows through coil 410, and a magnetic field opposite to the north magnetic field of driven magnet 110 is produced between driven magnet 110 and driver magnet 210. This in effect eliminates the repulsion between the north pole 211 of driver magnet 210 and the north pole 111 of driven magnet 110. This allows driven magnet 110 to move through the resistance zone with dramatically reduced resistance.

The operation of the invention can be fine tuned by moving movable brush 431 closer to or farther from the center of driven disk 110. When driven disk 100 is spinning at high velocity, energy consumption can be minimized by moving brush 431 outward, where it will be in contact with plate 430 for less time, not only in absolute terms but also as a percentage of the total time elapsed per revolution.

In the preferred embodiment, driver magnet 210 is stronger than driven magnets 110, 120, and 130.

The moving pulsed coil embodiment has two advantages over the fixed pulsed coil embodiment. Since driven magnet 110 is not as strong as driver magnet 210, a smaller voltage is required to cancel the north magnetic field of driven disk 110 than to cancel the north magnetic field of driver disk 210. Moreover, it is not necessary to cancel the entire north magnetic field of driven disk 110. It is not even necessary to cancel this field at the point where it is strongest, along the line of the north-south axis of driven magnet 110 perpendicular to its center. It is only necessary to cancel the relatively weaker part of the north magnetic field of this relatively weaker driven magnet 110 that lies in the direction toward the north pole 211 of driver magnet 210. Thus, only a very small voltage and current is required to counteract that portion of the north magnetic field of driven magnet 110 that opposes its crossing the resistance zone. Therefore, this coil will consume a very small amount of energy. As in the above embodiment, this voltage is only applied for a small fraction of the time. Together these factors minimize the power required to run the apparatus.

In both of the above embodiments, it is not necessary to reduce the appropriate magnetic field to zero. Even with some remaining net magnetic force in the counterclockwise direction, continuous operation will be possible as long as driven disk 100 has sufficient accumulated kinetic energy from the propulsion phase to continue to move clockwise through the resistance phase so that driven magnet 110 arrives at the point of no return 106 with a velocity equal to or greater than the velocity it had when driven magnet 110 was at the point of no return 106 on the previous revolution.

It is advantageous for driven disk 110 to have substantial mass, so that it has the effect of a flywheel. When the disk has substantial mass and is moving at a relatively high angular velocity, driven magnet 110 is able to cross the resistance zone in a small amount of time. Also, when its mass and angular velocity are high, the accumulated kinetic energy can overcome some counterclockwise force between the north pole 211 of driver magnet 210 and the north pole 111 of driven magnet 110 driven disk, and driven disk 210 can arrive at the point of no return with considerable velocity even if the magnetic field produced by coil 410 does not entirely cancel the north magnetic field of driven magnet 110 in the direction of driver magnet 210. These factors allow for the minimization of both the electrical energy required to drive coil 410 and the time during which this energy must be expended, thus minimizing the power consumed.

### DESCRIPTION OF THE PREFERRED EMBODIMENT

The preferred embodiment combines the features of several other embodiments to optimize the functioning of the apparatus, minimize the power consumption, and maximize the net energy generated.

The moving modulated coil with optimization embodiment has additional advantages. In the moving pulsed coil embodiment, the full voltage of the system is applied to coil 410 the entire time that magnet 110 is in the resistance zone and movable brush 431 makes contact with plate 430. The repulsion that provides a counterproductive, counterclockwise force, however, is not constant. This results in more expenditure of energy than is necessary to counteract the repulsion that takes place when a magnet is in the resistance zone.

The purpose of control module 520 is to minimize the expenditure of energy by modulating and optimizing the voltage and the resulting current flowing through coil 410 when driven magnet 110 (or another magnet) is in the resistance zone. In one embodiment, control module 520 controls the current flowing through coil 410 in the following way.

The input to control module 520 is from strain gauge 510 via wires 511 and 512. Strain gauge 510 produces a voltage across wires 511 and 512 that is proportional to the pressure in the counterclockwise direction (direction X at this point) applied by driven magnet 110 to strain gauge 510. When driven magnet 510 enters the resistance zone, the repulsion between the north pole 111 of driven magnet 110 and the north pole 211 of driver magnet 210 creates a counterclockwise force on magnet 110, resulting in a positive force on strain gauge 510. This produces a positive voltage input to control module 520.

When driven magnet 110 enters the resistance zone and movable brush 431 makes contact with plate 430, the circuit is completed, which in the absence of control module 520 would result in the full voltage of the system being applied to coil 410. (All other components have negligible resistance.) Control module 520 is programmed, however, so that initially there is no voltage differential between wire 433 and wire 434, resulting in no voltage being applied to coil 410. Initially, since the voltage applied to coil 410 is zero, coil 410 does nothing to counteract the repulsion between north pole 211 of driver magnet 210 and north pole 111 of driven magnet 110. This is appropriate at this point, since there is still very little repulsion, because the respective north poles of magnets 210 and 110 are not close. Energy consumption is minimized at the beginning of the passage of the driven magnet through the resistance by expending very little energy until the repulsion increases.

Control module 520 is programmed so that the incremental increase in the voltage between wire 433 and wire 434 in each brief time period is proportional to the input voltage applied by wires 511 and 512, which in turn is proportional to the repulsion that impedes the clockwise rotation of driven disk 100. Those skilled in the art can easily produce such a module using standard electronic components.

As driven magnet 110 moves further into the resistance zone, the repulsion increases, and the voltage (and corresponding current) increases across coil 410. This creates a south magnetic field that counteracts the repulsion. Additional voltage (and the corresponding current) is applied only to the extent that it is necessary to counteract the increasing counterproductive repulsion as the disk continues to rotate. In this way, the expenditure of energy is optimized.

This apparatus increases the current generating the counterbalancing magnetic field of the coil only as much as is necessary at each point to cancel the repulsion of the respective permanent magnets. If the magnetic field of the coil that is counteracting the repulsion is equal to the magnetic field of the driven magnet that is generating the repulsion (in the operative direction and position, considering with the opposite magnetic field of the driver magnet), then there is no further increase in the current and corresponding magnetic field of the coil. The current necessary to maintain the magnetic field generated by the coil remains, however, since it is exactly the correct current to counteract the counterproductive repulsion at this point.

As soon as the driven magnet 110 reaches the point of no return, movable brush 431 ceases to make contact with plate 430, and the current flow stops. The coil 410 no longer creates a south pole between the north poles of magnets 110 and 210, and the full repulsion between the north poles of the respective magnets contributes to clockwise motion of driven disk 110.

In the initial learning embodiment, control module 520 is more sophisticated than in the above described embodiments. It is capable of taking into account in its calculations the position of the disk 100 at each point in time. It is capable of learning a pattern of input voltage change (from strain gauge 510) and later reproducing a corresponding pattern of output voltage with the same shape, and of modulating the amplitude of that output voltage as described below.

Those skilled in the art can readily see how control module 510 can learn a pattern of input voltage change, incorporate this pattern into a template for output voltage change, and later reproduce the output voltage according to the pattern of the template.

Those skilled in the art can readily see how control module 510 can include in its calculations the position of disk 100 at each point in time as magnet 110 moves through the resistance zone. One simple way of accomplishing this is to have a directed light source on disk 100 and a series of light sensors in a circular configuration, such that the activation of each sensor corresponds to a specific position of the disk. This configuration is independent of the velocity (or changes in velocity) with which disk 100 rotates. An alternative would be to include an inertial navigation module affixed to disk 100. When the apparatus is in motion and spinning at a relatively constant velocity, a single light source (or even a hole in the disk with a light behind it) and a single light sensor could record the timing of each revolution, and the position of the disk at any point in time could be determined by interpolation and extrapolation.

First, in the learning phase of operation, movable disk 100 is repeatedly forcibly moved clockwise so that magnet 110 moves through the resistance zone. In the first iteration, control module 520 records the pattern of voltage input from strain gauge 510 as magnet 110 moves through the resistance zone, which is proportional to the counterclockwise force applied due to the repulsion of magnets 210 and 110 during this phase. Control module 520 makes a template of this pattern of voltage change. Then movable disk 100 is again forcibly moved through the resistance zone while control module applies a voltage in the same pattern, according to the recorded template, at an appropriate peak amplitude, across wires 433 and 434. Coil 410 produces a counterbalancing magnetic field with the same pattern as the pattern of resistance previously recorded, which counteracts the repulsion of magnets 201 and 110 during the resistance phase. Initially, this pattern is at an arbitrary amplitude estimated to be approximately sufficient to just cancel the repulsion at each point as the apparatus moves through the resistance zone so that there will be no net resistance.

This learning procedure is then repeated. Disk 100 is forcibly rotated such that magnet 110 moves through the resistance zone. The pattern of voltage input from strain gauge 510 is again recorded, while control module 520 is applying the voltage that produces the counterbalancing magnetic field in coil 410. If the voltage output of control module 520 is not the correct amplitude to reduce the resistance to zero at each point, a new pattern is recorded. This pattern is added to the previously calculated pattern of voltage output to be produced by control module 520, embodied in the template. If the resistance to clockwise motion is still greater than zero, the amplitude of the template is increased. If the resistance is less than zero, i.e., there is net force in a clockwise direction while the apparatus moves through the resistance zone, then the amplitude of the template is decreased. This process is repeated until the template is correct so that control module 520 applies the correct voltage pattern to modulate the current through coil 410 such that the corresponding magnetic field cancels the repulsion between magnets 210 and 110 at each point as magnet 110 traverses the resistance zone.

In the real-time learning embodiment, the apparatus initially functions according to the moving modulated coil with optimization embodiment. On the first revolution, control module 520 produces a template identical to the pattern calculated and implemented according to this algorithm. It applies voltage in a pattern according to this template in the next revolution, and also records the pattern of any deviations from zero repulsion as described above. Then it uses this pattern in the learning procedure described above, modifies the template accordingly to minimize any deviations from the template that will produce zero repulsion at each point in the resistance zone. It repeats this process on each revolution. Thus it learns, refines, optimizes, and implements the optimal pattern while operating. This algorithm also takes into account any changes that may take place due to changes in angular velocity, heating up of the system, or other known, unknown, or random factors affecting performance.

It can easily be seen that any of the embodiments that include control module 520 can be implemented without brushes 421 and 431 and plates 420 and 430 by programming control module 520 to break the circuit when the apparatus is in the propulsion zone, and including a method such as those described above for determining the position and velocity of the disk. In such an embodiment, control module 520 is connected directly to the negative voltage source and coil 410 is connected directly to the positive voltage source. The technology for supplying continuous electrical input to components on a rotating disk is well known to those skilled in the art.

It can be readily seen that the optimization procedures that characterize the moving modulated coil with optimization embodiment, the initial learning embodiment, the real-time learning embodiment, and the real-time learning with additional optimization embodiment (described below) can be applied to the fixed pulsed coil embodiment, with the voltage to fixed pulsed coil 610 being modulated instead of the voltage to moving pulsed coil 410.

The preferred embodiment, also known as the real-time learning embodiment with additional optimization, is based on a combination of the moving modulated coil with optimization embodiment and the real-time learning environment. The real-time learning embodiment with additional optimization is the same as the real-time learning embodiment described immediately above, except for the following. Control module 520 measures the repulsion (or attraction) at each point by recording the input voltage from strain gauge 510, and in real time adds or subtracts an amount proportional to this resistance from the next point in the template. The resulting modified template is applied, point by point, in real time to the output voltage on the same revolution where the new template is being generated. This template, as modified on this revolution of the disk, becomes the template for the next revolution, where it is again optimized, and so on with each revolution.

Note that the preferred embodiment, the real-time learning embodiment with additional optimization, differs from the moving modulated coil with optimization embodiment in that the former begins with a known template and adjusts each point in the template by an absolute amount of voltage determined by the input voltage, and the latter begins with no voltage and no template and continually adjusts the rate of increase in the output voltage by an amount determined by the input voltage.

In the preferred embodiment, the apparatus generates more energy through the generating coils than it expends in the electromagnets. Some of the energy so generated is fed back into the circuit that powers the electromagnets, either directly, or through a converter, transformer and/or storage device. Thus the system becomes a self-powering device that produces a net surplus of energy.

### Additional Embodiments

The mechanical embodiment applies the principles of the lever, energy-storing mechanism, ratchet, selective and intermittent isolation, and resonant frequency to minimize the counterproductive, counterclockwise forces and maximize the productive, clockwise forces on the driven disk during the resistance phase, without diminishing the productive forces during the propulsion phase. The mechanical embodiment applies a series of levers, a flexible lever, a ratchet, several components attached to the driven disk, and an apparatus fixed with respect to the earth to accomplish this.

The mechanical embodiment is illustrated in FIGS. 6a and 6b.

In the mechanical embodiment, driven magnet 110 and the other driven magnets are not fixed with reference to driven disk 100. Driven magnet 110 is attached to rigid lever 710, which is free to rotate about fulcrum 711. During the attraction phase and the repulsion phase, post 113 prevents driven magnet 110 from moving in the clockwise direction with respect to driven disk 100, so the magnetic forces of attraction and repulsion are translated to the disk, resulting in angular acceleration in the clockwise direction. This is essentially the same as in the attraction and repulsion phases of all other embodiments.

As driven magnet 110 approaches the resistance zone, flexible lever 740 encounters spring-hinged ratchet post 743. The post applies a very slight clockwise force to the flexible lever. The flexible lever applies a very slight equal and opposite counterclockwise force to the top of the post. The post bends at the hinge in response to this force, and allows the disk to which it is fixed to continue to move in a clockwise direction so that the post is past the flexible lever (on the −X side of the flexible lever). The post then snaps back to its vertical configuration, in which it is rigid with respect to clockwise force.

When driven magnet 110 enters the resistance zone as the disk continues to rotate clockwise, the repulsion between the like poles of magnets 110 and 210 exert a counterclockwise force on magnet 110. In response to this force, magnet 110 and the rigid lever 710 to which it is attached rotate in a counterclockwise direction with respect to fulcrum 711 (and disk 100). This results in a clockwise rotation of the rigid lever 720, to which rigid lever 710 is attached by a hinge. This results in a displacement of loop 722 in the X direction. (Since the loop is at the center of disk 100, this displacement is almost entirely radial, and has a negligible clockwise or counterclockwise component.)

Loop 722 is coupled to the apparatus that is attached to the immovable platform, rather than to disk 100. The displacement in the X direction of loop 722 produces a displacement in the X direction of cylinder 731 and rigid bar 730 to which it is fixed. This in turn results in a displacement in the X direction of the attached end of flexible lever 740.

So far, this phenomenon has been described in terms of displacements. It can readily be seen that it could also be described in terms of the forces that produce each of these displacements.

Flexible lever 740 is fixed at fulcrum 751 yet free to rotate. When rigid bar 730 applies a force in the X direction to the attached end of flexible lever 740, this force is translated to fulcrum 751, and through it to fixed horizontal bar 750, through it to fixed post 752 and to the earth or the immovable platform. Since the earth is virtually immovable, fulcrum 751 applies an equal and opposite force to the center of flexible lever 740, in the −X direction.

This force in the −X direction is conveyed by the flexible lever to both its ends. At the end of the flexible lever closest to the perimeter of disk 100 (the distal end), the flexible lever applies a force in the −X direction to spring-hinged ratchet post 743. Since this post is rigid with respect to displacement in this direction and is attached to disk 100, the post applies a force in the −X direction to disk 100. In this configuration, a force in the −X direction is a clockwise force.

In this way, the counterclockwise force applied by driver magnet 210 to driven magnet 110 when the latter is in the resistance zone is largely translated into a clockwise force. This serves to maintain the angular velocity gained during the propulsion phase.

Another way of describing this is that the disk and its attached magnets are selectively and intermittently isolated from the earth (with respect to rotational motion) in the propulsion phase, when the forces of the respective magnets accelerate the disk in the clockwise direction. Then, during the time and in the configuration when the forces of the respective magnets would otherwise oppose this clockwise motion, the system is selectively and intermittently coupled with the earth. Thus the transient magnetic forces in the unproductive, counterclockwise direction are counterbalanced by equal and opposite forces resulting from this coupling to the earth and the large inertia of the earth. These counterproductive forces are largely transformed into productive forces, with respect to clockwise motion of the disk.

The productive and counterproductive forces on the disk during the resistance phase are as follows. Fulcrum 711 exerts a counterclockwise force on the disk. Fulcrum 721 exerts a clockwise force on the disk. Post 743 exerts a clockwise force on the disk.

As the disk moves in the clockwise direction, post 743 will move away from the end of the flexible lever. It can readily be seen that the position of fulcrum 751 relative to the flexible lever can be adjusted so that the flexible lever maintains contact and adequate force despite this motion. To this end, fulcrum 751 is closer to bar 730 than to post 743, resulting in a greater range of motion at the distal end of the flexible lever than at the central end. (A similar effect can be produced by adjusting the position of other fulcrums.)

The mechanical energy storing quality of the flexible lever further contributes to this phenomenon. As the disk progresses in a clockwise direction while in the resistance zone, rigid bar 730 displaces the central end of the flexible lever in the X direction. The flexible lever is fixed in the middle with respect to lateral motion at fulcrum 751. Thus at its distal end, the flexible lever applies a force in the −X direction to spring-hinged ratchet post 743. The post applies an equal and opposite force. With forces in the X direction at both its ends and a force in the −X direction in the middle, the flexible lever bends.

The forces applied by the flexible lever to both its ends and the middle vary directly with its displacement from a straight configuration.

As the disk progresses in the clockwise direction, and magnet 110 moves further in the opposite direction with respect to the disk, the flexible lever is bent further. The forces applied to the disk at fulcrums 711 and 721 (and to the earth through fulcrum 751) increase monotonically with the displacement of the flexible lever.

Fulcrum 711 applies a force in the clockwise direction to rigid lever 710, which applies a force in a clockwise direction to driven magnet 110. This is opposed by a counterclockwise force resulting from the repulsion of the like poles of driven magnet 110 and driver magnet 210. The more the disk rotates, the closer driven magnet is to driver magnet 201, and the greater the force between them—at this point, a repulsive force. As the disk rotates further clockwise in the resistance zone, all of these forces increase monotonically.

When driven magnet 110 is in the resistance zone, the repulsion of the like poles of driver magnet 210 and driven magnet 110 apply a counterclockwise force on the disk, thus decreasing its angular velocity or stopping it altogether. The overall effect of the apparatus of the mechanical embodiment is to transform some of this counterclockwise force into clockwise force applied at post 743 and fulcrum 721.

If the angular momentum of the rotating disk is sufficient, at some point the clockwise forces on the disk exerted at post 743 and fulcrum 721 outweigh the counterclockwise force applied to the disk at fulcrum 711. The driven magnet 110 then moves very quickly through the resistance zone as flexible lever 740 returns to a straight configuration and the disk continues to rotate.

The efficiency of the mechanical embodiment is increased when the speed of rotation of the disk, the flexibility and time response of the flexible lever, and the placement of the fulcrums are such that the oscillations of the energy-storing mechanism in each revolution of the disk take place at the resonant frequency of the energy-storing mechanism, or at a multiple of the resonant frequency. When this is the case, energy from previous revolutions can be stored in oscillations of the energy-storing mechanism, thus reducing the additional energy required to produce the distortion of the energy-storing mechanism on each subsequent revolution.

Those skilled in the art can readily see how the speed of rotation of the disk can be controlled, and/or the positioning of the fulcrums can be adjusted, so that the oscillations of the energy-storing mechanism in each revolution of the disk take place at the resonant frequency of the energy-storing mechanism, or at a multiple of the resonant frequency.

The mechanical embodiment can work in conjunction with any of the other embodiments of the invention.

The mechanical embodiment allows driven magnet 110 to move through the region of highest resistance in the resistance zone more quickly than in the configurations in which driven magnet 110 is fixed to disk 100. This is a combination of two factors. First, since some of the counterclockwise force applied to the disk has been transformed to clockwise force, the disk is moving at a higher angular velocity. Second, as flexible lever 740 returns to a straight configuration, driven magnet 110 moves clockwise with respect to disk 100, and thus is moving past driver magnet 210 faster than it would if fixed to the disk.

The mechanical embodiment, when used in conjunction with the other embodiments, serves to minimize the energy expended in generating the counterbalancing magnetic forces in coil 410 or coil 610, thus increasing the efficiency and net energy output of the system.

Those skilled in the art can clearly see that this embodiment can be implemented in several different ways that embody the same essential principles. For example, flexible lever 740 could be replaced by a stiff lever, and instead of a fixed fulcrum at fulcrum 751, this fixed lever could be attached to fixed horizontal bar 750 by a spring or similar mechanism that applies a counterbalancing force that varies monotonically with its displacement through stretching or compression. Alternatively, the flexible lever could be replaced with a stiff lever, and hinge 712 could be replaced by a spring or stretchable band that applies a counterbalancing force that varies monotonically with the degree to which it is stretched. In either case, some of the counterclockwise force generated by the repulsion of the like poles of magnets 110 and 210 would be similarly transferred to a clockwise force at post 743 and fulcrum 721.

### Summary of Major Advantages of the Invention

The present invention produces substantial mechanical energy with a very small consumption of pulsed and modulated electrical energy. This mechanical energy can be used to perform work. Thus the invention provides an efficient method to apply electrical energy to perform mechanical work.

Under highly efficient conditions, with minimal friction, powerful magnets, and taking advantage of the novel positioning of the pulsed coils and optimization procedures of the current invention—with or without the transformation of counterproductive, counterclockwise force to productive, clockwise force with the mechanical embodiment—more electrical or mechanical energy can be produced than the energy required to drive the system. Thus the invention provides method for generating electrical or mechanical energy.

An advantage of all of the optimisation procedures described above is that they minimise the amount of energy consumed by the system in driving the rotational motion of the fixed disk 100, thus making the system more efficient. The mechanical embodiment has the same advantage.

Another advantage of the invention is that some of the electrical energy produced in coils 910 and 920 can be converted and fed back to the system to provide the input energy required to power the apparatus, with a net gain of energy.

Virtually all of the electrical generators actually in use in the prior art comprise various methods of converting mechanical or electromagnetic energy to electricity. Coal-powered and nuclear-powered plants generate heat, which is transformed to mechanical energy and then converted to electricity. Hydroelectric plants, wind power generators, tidal power generators, etc., capture naturally occurring mechanical energy and convert it to electrical energy. Solar power generators capture electromagnetic energy and convert it to electricity.

The present invention has a significant advantage over all such systems in that it does not require input of mechanical energy, heat, or electromagnetic energy to operate. It relies on continually reconfiguring permanent magnets. These magnets provide a force that can be applied across a distance to do work, and do not get expended or diminished in the process. Nor do permanent magnets require outside power to maintain this force.

Since the optimization procedures and other novel features of the invention are sufficient to provide a high enough level of efficiency that more electrical power is generated than the power expended, the invention provides a method for generating electrical power without expending fuel or requiring other input such as hydroelectric power, wind power, solar power, etc. Not only does the system require no outside energy to run, it has few moving parts, and the parts and the system degrade very little even with long, continuous operation. It is long lasting and durable.

The placement of the driven magnets such that their axes are tangential to the disk, the shape of these magnets as being approximately disk shaped—that is, relatively short and wide—along with the use of a fixed magnet that is approximately cylindrical—that is, relatively long with respect to its width—with one pole facing the disk combine to produce a novel configuration in which both the attraction of opposite magnetic poles and the repulsion of like magnetic poles of natural magnets contribute to the generation of mechanical and ultimately electrical energy. This provides the advantage of a more efficient system, with greater output energy compared to its input energy.

The novel optimisation procedures provide an additional advantage, in that they further increase the efficiency of the system by minimizing the expenditure of energy required to drive the coils that generate the magnetic forces that counter the counterproductive magnetic forces that occur when a driven magnet is in the resistance zone.

Some other techniques available in the prior art are purported to generate electricity without input of energy from outside the system. Even if such systems do work, the present invention provides major advantages over the prior art. The present invention provides a novel shape, configuration, and placement of magnets, a novel placement of coils, a novel pulsing of the electrical input, and a novel modulation of the shape of the pulses that minimize the consumption of energy required to operate the system. The invention provides a novel method for optimizing the shape and time course of the electrical pulses and the efficiency of its operation, thereby further minimizing the power required to operate the apparatus. The current state of the art lacks these novel features and techniques.

The prior art includes a fundamentally different configuration designed to accomplish a similar purpose to the present invention. In this configuration, the rotor magnets that are attached to the rotating disks are mounted radially, with one pole facing outwards. Instead of fixed driver magnet 210, an iron cylinder is fixed near the edge of the disk. As the disk rotates in one direction (say, clockwise), a magnet is attracted to the iron cylinder, and the resulting force accelerates the disk. When the rotor magnet passes the cylinder, however, it is still attracted to the cylinder, so the magnetic force works against the desired clockwise motion. To counterbalance this, when the magnet reaches the iron cylinder, a current is run through a coil surrounding the iron cylinder, creating an electromagnet with a like pole facing the outward-facing pole of the magnet fixed to the disk. For a brief period, this creates repulsion (or at least decreases the attraction), which reduces the deceleration of the disk as the magnets recede from the iron bar (or, if strong enough, accelerates the disk in the desired clockwise direction).

The present invention, however, is more efficient than such a configuration. The tangentially mounted driven magnets provide productive force through both attraction and repulsion, in the attraction zone and the repulsion zone respectively. Moreover, both the fixed pulsed coil embodiment and the moving pulsed coil embodiment of the invention consume only a small fraction of the energy that would be required to transform an iron bar into an electromagnet as in the prior art. The novel placing of the coils in the present invention serve to minimize the energy consumption necessary. The optimizing procedures further minimize the energy consumed. This makes the present invention more efficient and more viable as an energy generating apparatus than what is available in the present art.

As compared to such apparatus available in the prior art, the present invention uses less energy per unit time, and consumes energy for a much lesser percentage of the total time the apparatus is in operation. Since the coil 610 is closer than driver magnet 210 to driven magnet 110, and coil 410 is closer than driven magnet 110 to driver magnet 210, and since magnetic fields fall off quickly with distance, a much smaller magnetic field—and hence a much smaller voltage and/or current and thus less energy—will be required to cancel the repulsion between driver magnet 210 and driven magnet 110 than would be required to produce an electromagnet of equal strength to driver magnet 210. Moreover, due to the tangential mounting and disk-like shape of the driven magnets and the novel placement of coil 410, this coil only needs to counteract a relatively weak region of the magnetic field of driven magnet 110, far from the line perpendicular to the center of the disk-shaped magnet, where the magnetic field is strongest.

The prior art also includes some systems for generating mechanical energy (which can be converted to electrical energy) where the generation of mechanical energy is accomplished solely through the use of permanent magnets, without the pulsed electrical coils that comprise a feature of the present invention. Such systems rely on very small net directional differences in force generated by complicated configurations of numerous magnets with specialized shapes and sizes. They generate only a small amount of power, particularly when compared to the size and complexity of the system and the cost of the components. The present system has several advantages. It is simpler and more cost effective; requires less unusual, expensive, and specialized magnets; is more efficient; and can generate more power with a relatively small, simple, and easily constructed system.

The present invention provides a unique, efficient, novel method for generating electrical power without input of energy from outside the system. This provides obvious advantages over the systems now in general use, which depend on energy input from outside the system. In the systems now in common use, this energy must come either from the consumption of fuel or from an additional apparatus to capture naturally occurring mechanical or electromagnetic energy.

As compared to the other existing systems that purport to generate electricity without any outside energy input, the present system has the advantage of being highly efficient, highly effective, capable of optimizing performance as it runs, simple and cost effective to build and operate, powerful, and durable.

Moreover, the mechanical embodiment allows the system to combine a novel method of converting counterproductive magnetic force to productive force through mechanical means, which when combined with the electrical-coil-based embodiments of the invention further increases efficiency of the system.

I claim:

1. A method and apparatus for generating at least one of mechanical energy and electrical energy comprising the following elements:
A freely rotating disk fixed at the center to a relatively stationary platform;
Wherein said freely rotating disk is free to rotate in either of two directions, the productive direction (conventionally clockwise) and the counterproductive direction (conventionally counterclockwise),
At least one rotating driven permanent magnet affixed to said disk with the axis of said magnet tangential to the outer edge of the disk;
At least one fixed driver permanent magnet affixed to said stationary platform with the axis of said magnet radial to said disk;
At least one intermittent electrical circuit, comprising the following components:
at least one continuous connector comprising an electrically conductive material; at least one intermittent connector comprising an electrically conductive material; at least one electrical power source, comprising a positive electrical pole and a negative electrical pole;
Wherein the possible relative positions of said permanent magnets and said disk comprise the following:
at least one attraction zone, comprising a range of positions wherein the net angular magnetic force applied by said permanent magnets is a force of attraction in the productive direction; and
at least one repulsion zone, comprising a range of positions wherein the net angular magnetic force applied by said permanent magnets is a force of repulsion in the productive direction; and
at least one resistance zone, comprising a range of positions wherein the net angular magnetic force applied by said permanent magnets is a force in the counterproductive direction,
Wherein while said rotating driven permanent magnet is in the attraction zone the productive magnetic force of attraction between the opposite poles of said rotating driven magnet and said fixed driver magnet produces angular acceleration of said disk in the productive direction, and as the disk rotates said driven magnet approaches said driver magnet; and
Wherein while said rotating driven permanent magnet is in the repulsion zone the productive magnetic force of repulsion between the like poles of said rotating driven magnet and said fixed driver magnet produces angular acceleration of said disk in the productive direction, and as the disk rotates said driven magnet moves away from said driver magnet; and
Wherein while said rotating driven permanent magnet is in the resistance zone the counterproductive magnetic force of repulsion between the like poles of said rotating driven magnet and said fixed driver magnet, in the absence of any counterbalancing forces, would produce angular deceleration of said disk with respect to the productive direction;
Said method and apparatus further comprising
At least one intermittently powered coil of electrically conductive material, attached to and intermittently powered by said electrical circuit, and affixed to at least one of the following:
said platform, in the gap between the closest pole of said fixed magnet and the edge of said disk; and
said disk, situated such that when said rotating magnet passes said fixed magnet as said disk rotates, said intermittently powered coil will be in the gap between said two magnets, on the same side of said rotating magnet as the pole of said rotating magnet that matches the closest pole of said fixed magnet;
At least one control module that causes said electrical circuit to power said intermittently powered coil only when said permanent driven magnet is in said resistance zone, such that said intermittent circuit applies a voltage that generates a current through said intermittently powered coil only when said driven magnet is in the resistance zone, which current produces an intermittent magnetic field opposite to that of the pole of said driver magnet that faces said disk, and thereby said intermittent magnetic field counterbalances said counterproductive magnetic force between said permanent magnets; and
Wherein when said driven magnet is in the resistance zone, said intermittent magnetic field at least one of:
reduces the net counterproductive force of repulsion between the like poles of said driver magnet and said driven magnet, and thereby reduces the counterproductive magnetic force in the counterproductive direction, and thereby reduces the angular deceleration of said disk brought about by said counterproductive magnetic force; and
eliminates the net counterproductive force of repulsion between the like poles of said driver magnet and said driven magnet, and thereby eliminates the counterproductive magnetic force in the counterproductive direction, and thereby eliminates the angular deceleration of said disk that otherwise would brought about by said counterproductive magnetic force; and
reverses the net counterproductive force of repulsion between the like poles of said driver magnet and said driven magnet, and thereby reverses the counterproductive magnetic force in the counterproductive direction, and thereby produces angular acceleration of said disk even when said driven magnet is in the resistance zone.

2. The method and apparatus in claim 1 wherein
said control module modulates said voltage applied to said intermittently powered coil such that said voltages varies with at least one of
the relative position of said driven magnet with respect to said driver magnet; and
the counterproductive force applied by said permanent magnets, in the absence of any counterbalancing forces.

3. The method and apparatus in claim 2 wherein
said control module modulates said voltage applied to said intermittently powered coil such that said voltage varies monotonically with the counterproductive force applied by said permanent magnets.

4. The method and apparatus in claim 3 wherein
said apparatus further comprises at least one strain gauge; and
wherein said driven magnet is attached to said strain gauge and not directly to said disk, and said strain gauge is attached to said disk; and
wherein said strain gauge monitors said counterproductive magnetic force while said driven magnet is in the resistance zone; and
whereas said strain gauge conveys information regarding the magnitude of said counterproductive force to said control module; and
wherein said control module applies said information to modulate said voltage applied to said intermittently powered coil such that said voltage varies monotonically with said counterproductive magnetic force; and
wherein said intermittent magnetic force consequently thereby is modulated to more closely match and counterbalance said counterproductive magnetic force.

5. The method and apparatus in claim 1 wherein
said apparatus further comprises at least one power-generating coil, comprising a coil of an electrically conductive material around a magnetic but not magnetized core;
wherein said power-generating coil is positioned close to said rotating disk, with its axis radial to said disk; and
wherein as said rotating magnet approaches said power-generating coil, the moving magnetic field of said rotating magnetic field produces an electrical current in said coil; and
wherein as said rotating magnet recedes from said power-generating coil, the moving magnetic field of said rotating magnetic field produces an electrical current in said coil; and
wherein electrical power is generated thereby.

6. The method in claim 5 wherein at least some of said electrical power generated by said power-generating coil is routed to at least one of
said circuit;
a converter, from where is it routed to said circuit; and
a storage device, from where it is routed to said circuit.

7. The method and apparatus in claim 1 wherein
said apparatus is connected mechanically to a mechanism that applies the mechanical energy of the rotation of said disk to do work.

8. The method and apparatus in claim 1 wherein said apparatus further comprises the following additional mechanical components:
an interconnected series of levers, wherein
at least one of said levers is attached to said driven magnet, and said driven magnet is not directly attached to said disk;
at least one of said levers is attached to a fulcrum that is fixed with respect to said disk;
at least one of said levers is attached to a fulcrum that is fixed with respect to said platform;
said levers are connected in series;
said levers are configured in such a way that they transform a counterproductive force applied to said driven magnet while it is in the resistance zone to a productive force applied to said disk.

9. The method and apparatus in claim 8 wherein said apparatus further comprises the following additional mechanical components:
an energy-storing mechanism that exerts a counterbalancing force that varies monotonically with the displacement of said driven magnet in the counterproductive direction with respect to said disk, which mechanism is integrated with said series of levers in such a manner that said counterbalancing force is applied in a productive direction to a mechanism that is fixed with respect to said disk and thereby applied to said disk, said energy-storing mechanism comprising at least one of
a flexible lever that comprises one of said levers, wherein the counterbalancing force applied by said flexible lever varies monotonically with its deviation from a straight configuration; and
a compressible mechanism connecting one of said fulcrums with one of said levers, wherein a counterbalancing force applied by said compressible mechanism varies monotonically with the degree to which it is compressed; and
a stretchable mechanism connecting one of said fulcrums with one of said levers, wherein a counterbalancing force applied by said stretchable mechanism varies monotonically with the degree to which it is stretched.

10. The method and apparatus in claim 8 wherein said apparatus further comprises the following additional mechanical component:
a ratchet that is fixed with respect to said disk; and
wherein said ratchet is configured in such a manner as to allow said disk to move freely in a productive direction with respect to said lever that is attached to a fulcrum that is fixed with respect to said platform, and to disallow motion of one end of said lever in a productive direction with respect to said disk, thereby allowing the productive force applied by said series of levers to be applied intermittently to said disk without impeding the productive rotation of said disk at any time.

11. The method and apparatus in claim 9 wherein at least one of the speed of rotation of said disk and the configuration of said series of levers is controlled such that
said energy-storing mechanism oscillates; and
oscillations of said energy-storing mechanisms take place in conjunction with at least one of
the resonant frequency of said energy-storing mechanism; and
a multiple of the resonant frequency of said energy-storing mechanism.
